(19) United States
(12) Patent Application Publication
(10) Pub. No.: US 2019/0243740 A1
(43) Pub. Date: Aug. 8, 2019

(54) NON-TRANSITORY COMPUTER-READABLE RECORDING MEDIUM HAVING STORED THEREIN A DETERMINING PROGRAM, METHOD FOR DETERMINING, AND APPARATUS FOR DETERMINING

(71) Applicant: FUJITSU LIMITED, Kawasaki-shi (JP)

(72) Inventors: Seiji Kambe, Gifu (JP); Kazuyuki Tanaka, Kasugai (JP); MASASHI KATOU, Nagoya (JP); Naoaki Ono, Nagoya (JP); Akinobu Noda, Nagoya (JP); Tokutomi NAGAO, Tsushima (JP); Daiki Yoshikawa, Handa (JP); Masahiro FUKUDA, Nagoya (JP); Kazuyuki Sakai, Nissin (JP)

(73) Assignee: FUJITSU LIMITED, Kawasaki-shi (JP)

(21) Appl. No.: 16/266,172

(22) Filed: Feb. 4, 2019

(30) Foreign Application Priority Data
Feb. 6, 2018 (JP) 2018-018769

(51) Int. Cl. G06F 11/34; G06F 11/30; G06F 9/48

(52) U.S. Cl. CPC G06F 11/3495; G06F 9/4887; G06F 11/3006

(57) ABSTRACT

A determining program that executes a determination process comprising: specifying a monitoring target associated with a target job by referring to a memory configured to store a monitoring target in association with the target job, the monitoring target being monitored in a determination process, the determination process determining, based on whether the target job finishes by a first reference time point or within a first reference time period, whether the target job has abnormality; updating the first reference time point or the first reference time period to a second reference time point or a second reference time period, respectively, based on monitoring information obtained through monitoring the specified monitoring target; and determining, based on the second reference time point or the second reference time period, whether the target job has abnormality.

### CROSS-REFERENCE TO RELATED APPLICATION

This application is based upon and claims the benefit of priority of the prior Japanese Patent Application No. 2018-018769, filed on Feb. 6, 2018, the entire contents of which are incorporated herein by reference.

### FIELD

The embodiment disclosed herein relates to a non-transitory computer-readable recording medium having stored therein a determining program, a method for determining, and an apparatus for determining.

### BACKGROUND

In recent years, a market for the cloud technique has been growing for the merits of eliminating the requirement for purchase, operation, and maintenance of servers and software programs accompanied by a system construction.

In the transition from an on-premise system to a cloud system, batch operations that have been executed in the on-premise system tend to be migrated to the cloud system without any modifications (i.e., keeping the contents of the batch operations).

Patent Document 1: Japanese Laid-Open Patent Publication No. 2004-38516

Patent Document 2: Japanese Laid-Open Patent Publication No. 2013-164712

Patent Document 3: Japanese Laid-Open Patent Publication No. 2004-302937

Patent Document 4: Japanese Laid-Open Patent Publication No. 2014-49045

Patent Document 5: Japanese Laid-Open Patent Publication No. 2012-146049

Patent Document 6: Japanese Laid-Open Patent Publication No. 2015-57685

### SUMMARY

According to an aspect of the embodiment, there is provided a determining program that causes a computer to execute the following process including: specifying a monitoring target associated with a target job by referring to a memory configured to store a monitoring target in association with the target job, the monitoring target being monitored in a determination process, the determination process determining, based on whether the target job finishes by a first reference time point or within a first reference time period, whether the target job has abnormality; updating the first reference time point or the first reference time period to a second reference time point or a second reference time period, respectively, based on monitoring information obtained through monitoring the specified monitoring target; and determining, based on the second reference time point or the second reference time period, whether the target job has abnormality.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of the configuration of a determining system according to an example of an embodiment;

FIG. 2 is a block diagram schematically illustrating an example of the functional configuration of a server of an embodiment of an embodiment;

FIG. 3 is an example illustrating an example of job definition information;

FIG. 4 is an example illustrating an example of execution history information;

FIG. 5 is an example illustrating an example of job category information;

FIG. 6 is a diagram illustrating an example of abnormality detection of a preceding-job dependent type (normal case);

FIG. 7 is a diagram illustrating a comparative example of abnormality detection of a preceding-job dependent type (case of a preceding-job delay);

FIG. 8 is a diagram illustrating an example of abnormality detection of a preceding-job dependent type (case of a preceding-job delay);

FIG. 9 is a diagram illustrating a comparative example of abnormality detection of a preceding-job dependent type (case of preceding-job abnormality);

FIG. 10 is a diagram illustrating an example of abnormality detection of a preceding-job dependent type (case of preceding-job abnormality);

FIG. 11 is a diagram illustrating an example of abnormality detection of a NW (network) abnormality type (normal case);

FIG. 12 is a diagram illustrating a comparative example of abnormality detection of a NW abnormality type (case of NW delay);

FIG. 13 is a diagram illustrating an example of abnormality detection of a NW abnormality type (case of NW delay);

FIG. 14 is a diagram illustrating a comparative example of abnormality detection of a NW abnormality type (case of server down);

FIG. 15 is a diagram illustrating an example of abnormality detection of a NW abnormality type (case of server down);

FIG. 16 is a diagram illustrating an example of abnormality detection of a predetermined-time operation type (normal case);

FIG. 17 is a diagram illustrating an example of abnormality detection of a predetermined-time operation type (abnormal case);

FIG. 18 is a diagram illustrating an example of abnormality detection of a disk abnormality type (normal case);

FIG. 19 is a diagram illustrating a comparative example of abnormality detection of a disk abnormality type (case of disk delay);

FIG. 20 is a diagram illustrating an example of abnormality detection of a disk abnormality type (case of disk delay);

FIG. 21 is a diagram illustrating a comparative example of abnormality detection of a disk abnormality type (case of disk abnormality);

FIG. 22 is a diagram illustrating an example of abnormality detection of a disk abnormality type (case of disk abnormality);

FIG. 23 is a diagram illustrating an example of abnormality detection of a data type (normal case);

FIG. 24 is a diagram illustrating an example of abnormality detection of a data type (abnormal case);

FIG. 25 is a flow diagram illustrating an example of a succession of procedural steps of a job categorizing process according to an embodiment;

FIG. 26 is a flow diagram illustrating an example of a succession of procedural steps of job execution control according to an embodiment;

FIG. 27 is a flow diagram illustrating an example of a succession of procedural steps of an abnormality detection process of a job of preceding-job dependent type according to an embodiment;

FIG. 28 is a flow diagram illustrating an example of a succession of procedural steps of a job specifying process of a job of preceding-job dependent type according to an embodiment;

FIG. 29 is a flow diagram illustrating an example of a succession of procedural steps of abnormality detection process on a started job of according to an embodiment;

FIG. 30 is a flow diagram illustrating an example of a succession of procedural steps of abnormality detection process on a started job of according to an embodiment;

FIG. 31 is a flow diagram illustrating an example of a succession on procedural steps of abnormality detection process of a started job of according to an embodiment;

FIG. 32 is a flow diagram illustrating an example of a succession of procedural steps of abnormality detection process on a started job of according to an embodiment;

FIG. 33 is a block diagram illustrating an example of the hardware configuration of a computer according to an example of the embodiment;

FIG. 34 is a diagram illustrating an example of detecting NW abnormality (case of NW delay); and

FIG. 35 is a diagram illustrating an example of detecting NW abnormality (case of NW failure).

### DESCRIPTION OF EMBODIMENTS

Hereinafter, description will now be made in relation to an embodiment of the present invention with reference to the accompanying diagram. The embodiment to be detailed below is merely exemplary and does not have intention to exclude various modifications and applications of techniques not referred in the following embodiment. The following embodiment may be variously modified without departing from the scope thereof. Throughout the drawings used in the following embodiment, like reference numbers designate the same or substantially same parts and elements unless otherwise described.

### (1) Embodiment

In a cloud technique, multiple systems sometimes share hardware resources and/or software resources (sometimes collectively referred to as “resources”). Such multiple systems may be used by respective different users.

In transit of a system to a cloud system under a state where multiple systems uses common resources, a circumstance where the statuses of other systems using the common resources are blackboxed and are not grasped during the job operation in the cloud system may occur.

In such a circumstance, a problem caused by an influence of another system, which has not been risen in job operation in a traditional on-premise system, may rise.

Accordingly, a scheme to deal with on-premise environment sometimes fails to appropriately determine whether a job in cloud environment has abnormality. [0055]

### (1-1) Comparative Example

In a batch operation, abnormality in a job or job net is preferably detected at the early stage and rapidly recovered. Also in cloud environment, it is important to rapidly and exactly discriminate the normality from the abnormality of a job and/or job net.

Here, the term “job” represents a unit of work that the computer is caused to execute, and the term “job net” represents a cluster of one or more (correlated multiple) jobs. A “job net” may define the order of executing one or more jobs. Hereinafter, a “job” and/or a “job net” is sometimes referred to as simply a “job”.

In a batch operation, an example of a method for detecting abnormality in a job is that abnormality determination is made when a reference time period set on the basis of the operation history of the job expires or a reference time point also set on the basis of the operation history of the job comes. In this method, a job that has been executed within a reference time period or until a reference time point is regarded to be normal, and a job that has been executed beyond the reference time period or after the reference time point is regarded to be abnormal. An example of the reference time period is a scheduled execution time (time period) for which the job is to be executed, and an example of the reference time point is a scheduled start time point and/or a scheduled end time point at which the job is to start and/or end.

However, such a method for univocally determining the normality or abnormality of a job using a reference time period or a reference time point as a critical point has a possibility of erroneous determined in the following cases.

(A) The job is expected to normally finish within a margin time even if the job is being executed in a time period during which the job is considered to be abnormal if the job is being executed.

(B) Even if the job is being executed in a time period during which the job is considered to be normal if the job is being executed, the process is not entirely (or at least partly) being executed to have abnormality.

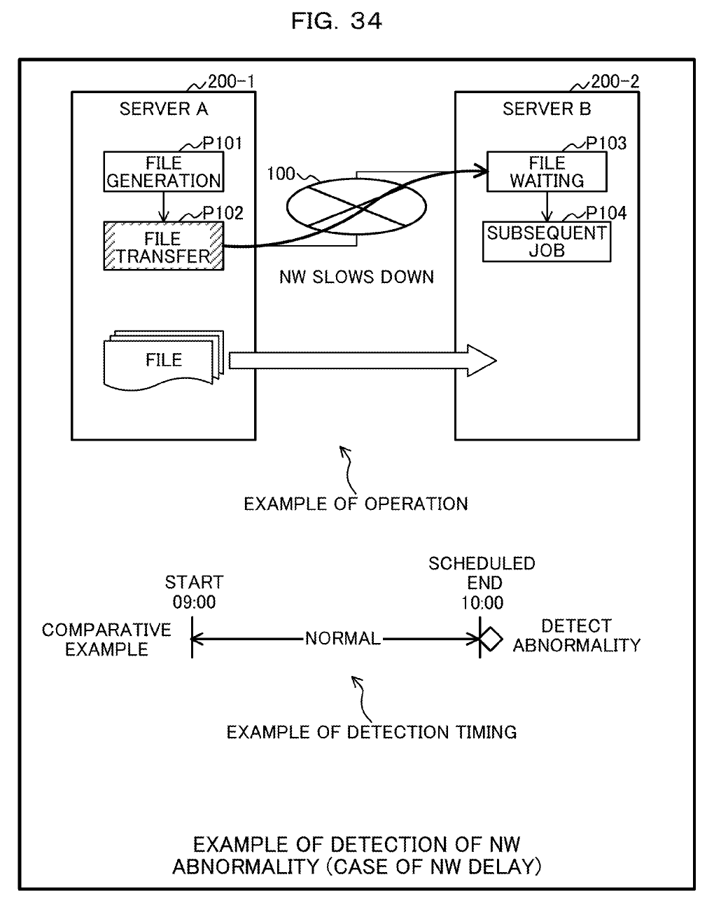

First of all, description will now be made in relation to the case (A). As exemplarily illustrated in FIG. 34, a file transfer job P102 executed by the server 200-1 is to be focused among jobs P101 to P104 executed by the servers 200-1 and 200-2. In the following description, the servers 200-1 and 200-2 are sometimes referred to as servers A and B, respectively.

The file transfer job P102 is a job that transfers a file to the server B through a network 100.

Assuming that the scheduled execution time period of the file transfer job P102 is 60 minutes, a manager (not illustrated) of the job determines that the job P102 is normal if the transfer process is completed as of ten o'clock in a case where the job P102 starts at nine o'clock. In contrast, the manager determines that the job P102 is abnormal if the transfer process is not completed at 10 o'clock.

Here, the completion of the transfer process may sometimes delay because the network 100 slows down to lower the transfer rate. In this case, even if the completion of the transfer process (normal end) is expected by waiting a little time (margin time, for example by waiting until 10:05) judging from the progress status of the transfer rate, the manager determines that the job P102 is abnormal when the time passes 10 o'clock.

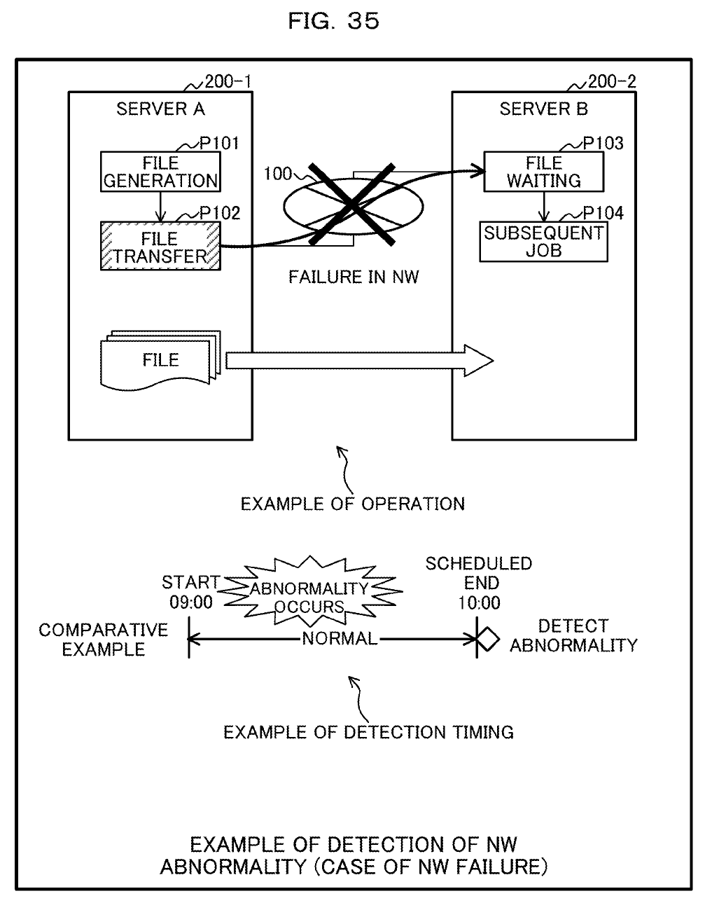

Next, description will now be made in relation to the case (B). As exemplarily illustrated in FIG. 35, the transfer process is sometimes not executed at all due to a failure (abnormality) that occurs in the network 100. In this case, the manager determines that the file transfer process P102 is normal during time period (nine to ten o'clock) during which the process is determined to be normal even if the transfer process is not started.

In addition to the above cases (A) and (B), the server A or B may have a delay or a failure unique to cloud environment, such as processing delay and a failure caused by an influence of a third party.

As described above, cloud environment may fail to appropriately determine abnormality of a job in a method using a reference time period or reference time point as performed in on-premise environment.

### (1-2) Example of an Embodiment

In the Foregoing Inconvenience in View, description will now be made in relation to a method for appropriately making a determination related to abnormality of a job on the basis of the characteristic of the job.

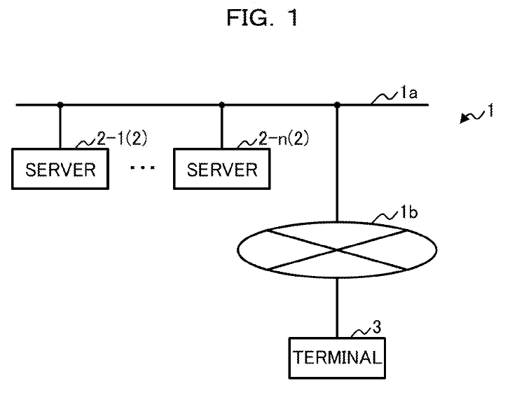

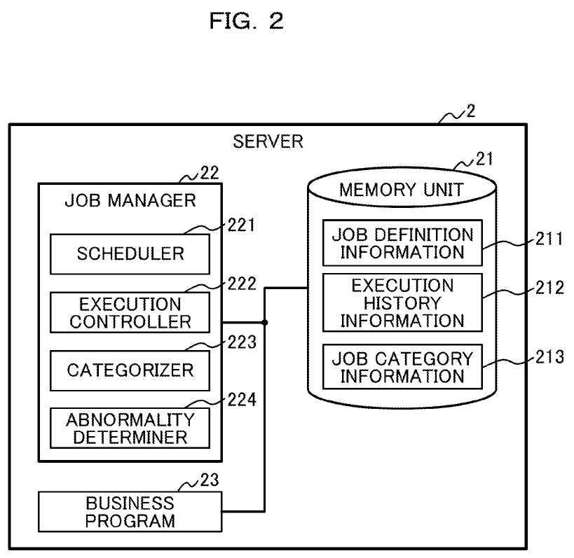

FIG. 1 is a diagram schematically illustrating an example of the configuration of a determining system 1 according to an example of an embodiment; and FIG. 2 is a block diagram schematically illustrating an example of functional configuration of a server according to an embodiment.

As illustrated in FIG. 1, the determining system 1 may exemplarily include multiple (“n” in the example of FIG. 1, n is an integer of two or more) servers 2-1 to 2-n and a terminal 3. When the servers 2-1 to 2-n are not discriminated from one another, the servers are represented simply by a reference number “2”.

The multiple servers 2 are examples of multiple computers used for providing cloud service, and the hardware resource and/or the software resource of each server 2 may be used in cloud computing. The multiple servers 2 may be communicably connected to one another via a network 1a such as a network infrastructure of the cloud service.

The terminal 3 is an example of a computer that accesses the cloud service provided by the multiple servers 2. The terminal 3 may be connected to, for example, a network 1b and may be bidirectionally and communicably connected to the servers 2 via the network 1b and a network 1a communicably connected to the network 1b.

At least one of the networks 1a and 1b may be at least one of an internet and an intranet containing a Local Area Network (LAN), a Wide Area Network (WAN), or the combination thereof. At least one of the networks 1a and 1b may include a virtual network such as a Virtual Private Network (VPN). Besides, at least one of the networks 1a and 1b may be at least one of a wired network and a wireless network.

### (1-3) Example of Functional Configuration of Server

Next, description will now be made in relation to an example of the functional configuration of the server 2 with reference to FIG. 2. In an embodiment, each server 2 executes multiple jobs and determines, based on whether the job finishes by a reference time point or within a reference time period, whether a target job has abnormality. The multiple jobs may include a series of jobs to be executed in, for example, a batch operation set by the terminal 3, and the target job may be a job to be executed.

As illustrated in FIG. 2, each server 2 exemplarily includes a memory unit 21, a job manager 22, and a business program 23.

The memory unit 21 is an example of a storing device that stores various pieces of information to be used in the processing by the server 2. The information stored in the memory unit 21 is to be detailed below in conjunction with the description of the function of the job manager 22. Examples of the memory unit 21 are one or more of a memory exemplified by a volatile memory such as a Random Access Memory (RAM); and a storing device exemplified by a storing apparatus such as a Hard Disk Drive (HDD) or a Solid State Drive (SSD).

The job manager 22 executes a job, and monitors and detects possible abnormality of job. As illustrated in FIG. 2, the job manager 22 may exemplarily include a scheduler 221, an execution controller 222, a categorizer 223, and an abnormality determiner 224.

The scheduler 221 instructs (requests) the execution controller 222 to execute a job in accordance with the definition of a start condition of a job which condition is set in job definition information 211.

The job definition information 211 is an example of definition information which is set for each server 2 that is to execute jobs and which defines the information related to each job to be executed in the same server 2. The information related to each job may include the definition of the job itself, the definition of the relationship of the job with its preceding and subsequent jobs. Examples of the information are the name of a business program 23 to be started, a start condition (e.g., a time point of the start), order of starting, and supplementary information of the job. Here, the business program 23 is a program executed as a job.

For example, the job definition information 211 may be sent from the terminal 3 to the server 2 through the networks 1a and 1b and set in the server 2 for automatic execution of the job. The business program 23 may be sent from the terminal 3 to the server 2 through the networks 1a and 1b and stored in a storing region in a part of the memory unit 21.

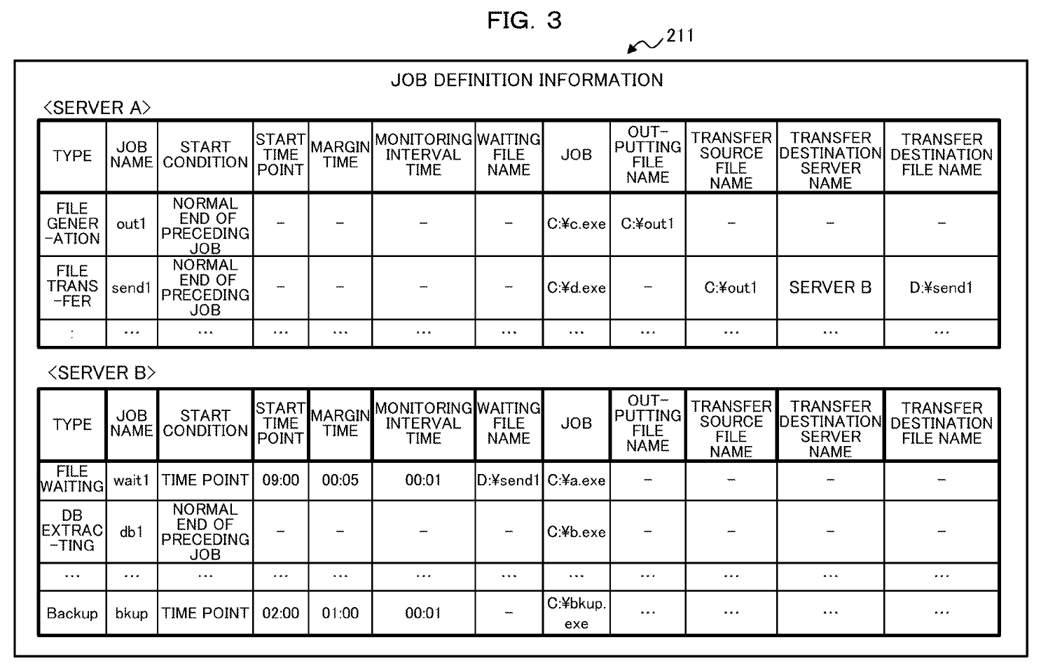

As illustrated in FIG. 3, the job definition information 211 may exemplarily include items of job type, job name, start condition, start time, margin time, and monitoring time interval. The job definition information 211 may further include items of waiting file name, program name to be executed as a job and its argument, outputting file name, transfer source file name (sender file name), transfer destination server name (receiver file name), and transfer destination file name.

The start condition is a condition on which the job starts, and for example, includes “normal end of preceding job”, which means that the job starts if the preceding job normally ends, and “time point”, which means the job is started when the set time point comes. The items of start time point, margin time, and monitoring time interval are set when the start condition is “time point”. The item “start time” is a time point at which the job starts. The item “margin time” is a delay time for which a delay of end of the started job is allowed in cases where the end of the job is later than the scheduled end time point (reference time point) or the end of the job is beyond the scheduled execution time period (reference time period). The item monitoring interval time is an interval at which a job being executed is monitored.

The item “waiting file name” is a file name (path) set in cases where the job type is “file waiting”. The program name and the argument of the program to be executed as a job are the file name (path) and the argument of the business program 23, respectively. The outputting file name is a file name (path) of a file that is to be output through the execution of the job in the server 2 and that is recognized by the server 2. The items of transfer source file name, transfer destination server name, and transfer destination file name are the file name (path) at the local server 2, the server name of a counterpart server 2, and a file name (path) at the transfer destination of the counterpart server 2 of a file that is to be transferred to the counterpart server 2 through being executed in the local server 2, respectively.

The memory unit 21 is an example of a storing device that stores a margin time for which a delay of finishing a job is allowed in association with the job.

For example, the scheduler 221 may generate, upon receipt of information to be registered in the job definition information 211 from the terminal 3, the job definition information 211 and store the job definition information 211 in the memory unit 21. Alternatively, the scheduler 221 may update the job definition information 211 stored in the memory unit 21.

The memory unit 21 may store a job cluster containing one or more (e.g., multiple related) jobs and/or a job net that defines the order of executing one or more jobs, for example.

The execution controller 222 executes, in obedience to an instruction from the scheduler 221, a job with reference to information related to the job defined in the job definition information 211, and also manages the status and the result of the execution of the job. For example, the information of the status and the result of the execution of the job may be notified from the execution controller 222 to the abnormality determiner 224 in response to the request from the abnormality determiner 224.

The execution controller 222 may store information related to the execution of the job, exemplified by the time points of starting and ending the job and the result of executing the job into the memory unit 21 to be the execution history information 212.

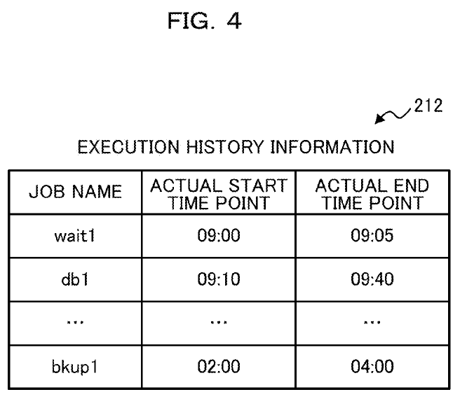

FIG. 4 illustrates an example of the execution history information 212. As illustrated in FIG. 4, the execution history information 212 may exemplarily include items of job name, actual start time point, and actual end time point.

The item “job name” is a job name described in the job definition information 211 and information to specify the job having been executed. The item “actual start time point” is a time point at which the execution of the job is activated (the job is started). The item “actual end time point” is a time point at which the execution of the job ends. The items of “actual start time point” and “actual end time point” may further include information representing data such as year, month, and day.

The items of “actual start time point” and “actual end time point” may be used for determining, by the abnormality determiner 224 to be detailed below, a scheduled end time point or a scheduled execution time period of the job being executed the same as a job of which the actual end time point is registered.

For example, the actual end time point may be used as a scheduled end time point of the same job being executed. Further alternatively, the scheduled end time point of a job may be calculated by calculating the average or the weighted average (e.g., calculating by weighing the latest actual time point) of the actual end time points of the same job registered in the execution history information 212.

Alternatively, the actual execution time period obtained by subtracting the actual start time point from the actual end time point may be regarded as the scheduled execution time period of the job being executed. Further alternatively, the average or the weighted average of the actual end time points of the same job registered in the execution history information 212 may be calculated and regarded as the scheduled execution time period of the same job being executed.

In cases where the start and/or end of the job is abnormal such as the job not being started or not being normally finished, information indicating abnormality or a blank may be set for at least one of the actual start time point and the actual end time point.

The execution history information 212 may further include items of information indicative of the status of a job being executed, status of processing the job, and presence or absence of abnormality of the job.

The categorizer 223 categorizes jobs to be executed in the server 2 on the basis of each job type set in the job definition information 211. For example, the categorizer 223 may categorize jobs set in the job definition information 211 on the basis of the characteristics related to the job types.

Here, description will now be made in relation to categorization of jobs. An optimum type of abnormality for determining whether a job is normal is different with the type of the job. In the example of FIGS. 34 and 35, whether a job is normal is appropriately determined by detecting network abnormality, not detecting abnormality based on the execution time period of the job.

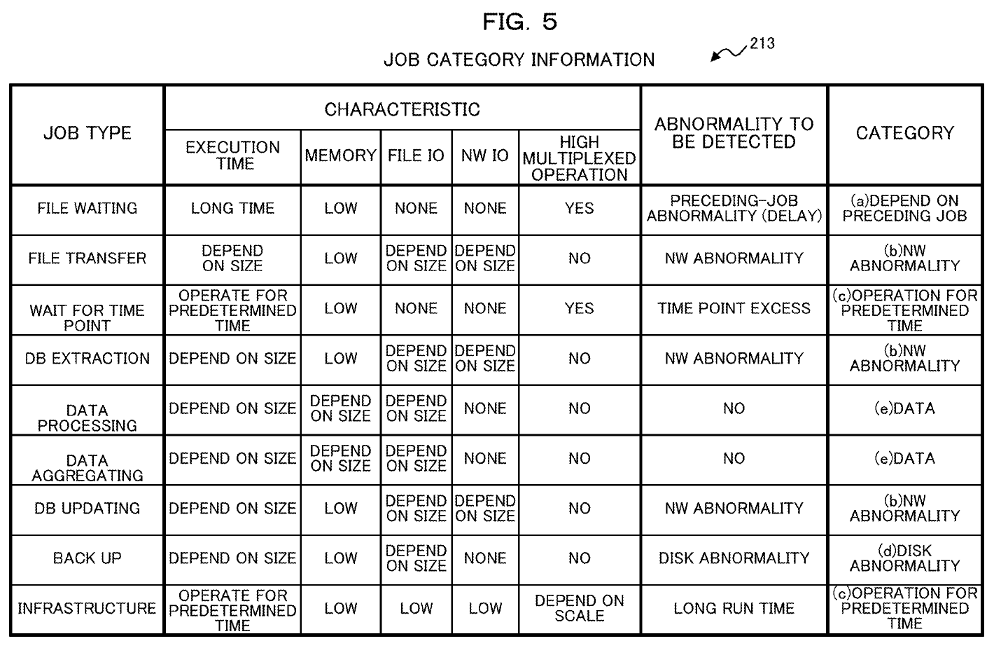

FIG. 5 illustrates an example of the job category information 213. Hereinafter, description will now be made in relation to the job category information 213. The job category information 213 is information that associates a job type with a category of job. The information set in the job category information 213 may be derived in the following procedure.

The following procedure describes the logic of categorizing the jobs on the basis of a job type with reference to, for example, a procedure of deriving the categories by a user using the terminal 3.

The association of a job type with a category of job may be set as the information derived in, for example, the following procedure beforehand in the job category information 213, and the categorizer 223 may categorize jobs to be executed with reference to the job category information 213.

For example, the job category information 213 sufficiently includes items of at least job type and category among the items of FIG. 5. The item of job type corresponds to the job types described in the job definition information 211. The item of category corresponds to segments based on characteristics of jobs related to the job type.

(I) The Job Type is Defined.

A batch operation consists of jobs of: file waiting, file transfer, wait for time point, DB (Database) extraction, data processing, data aggregating, DB update, backup, and infrastructure, which may be defined as the job types. Here, the categorizer 223 may determine the type of the job to be executed on the basis of the job category information 213.

(II) The Characteristic of the Job is Specified for Each Job Type.

The user determines, on the terminal 3, the characteristic of each job type mainly based on viewpoints of an execution time period, a memory usage, a file Input/Output (IO), a network IO, and high multiplexed operation, and inputs the determined characteristic into the job category information 213 as illustrated in FIG. 5. Examples of a job characteristic are the following (II-1) to (II-9).

(II-1) File Waiting

A file waiting job is a job that waits for a file and shifts to the subsequent job. Although being executed for a long time period, a file waiting job is a job merely waiting and therefore has a characteristic of “low” memory usage. If simultaneously waiting for multiple files, the file waiting job corresponds to a multiplexed operation. A file waiting job is not started unless the preceding job generates a file.

(II-2) File Transfer

A file transfer job transfers a file to another server 2 where the file is to be processed. The execution time period, the file IO, and the network IO of the job depend on the file size of the file to be transferred. A file transfer job is a job that merely transfers a file and therefore has a characteristic of “low” memory usage.

(II-3) Wait for Time Point

A “wait for time point” job is a job that waits until the time point and shifts to the subsequent job. A “wait for time point” job is a job executed for a predetermined time period, merely waits and therefore has a characteristic of “low” memory usage. If simultaneously waiting for multiple time points, the “wait for time point” job corresponds to a multiplexed operation.

(II-4) DB Extraction

A DB extraction job extracts data from the DB of a DB server 2, which one of the multiple servers 2 of FIG. 1. A DB extraction job merely extracts data and therefore has a characteristic of “low” memory usage. The execution time period, the file IO, and the network IO of the job depend on the data size of data to be extracted.

(II-5) Data Processing

A data processing job performs, on data extracted from a DB, data processing such as data format conversion, data combining, data inquiry, sorting, and data analysis. The execution time period, the memory usage, and the file IO of the job depend on the data size of data to be processed.

(II-6) Data Aggregating

A data aggregating job aggregates processed data. The execution time period, the memory usage, and the file IO of the job depend on the data size of data to be aggregated.

(II-7) DB Updating

A DB updating job updates the DB of the DB server 2. A DB updating job merely updates the DB and therefore has a characteristic of “low” memory usage. The execution time period, the file IO, and the network IO of the job depend on the data size of data to be updated.

(II-8) Backup

A backup job duplicates data in case of corruption and loss. A backup job is periodically executed. The execution time period and the file IO of the job depend on the data size of data to be duplicated.

(II-9) Infrastructure

An infrastructure job starts the server 2 and services for the start of the business. An infrastructure job operates for a predetermined time period, not fluctuating between days. The degree of multiplexing of the job depend on the number of servers 2 to be started and the number of services.

(III) The Abnormality to be Detected is Specified on the Basis of Find Characteristic.

The user specifies, on the terminal 3, specifies the type of “abnormality” to be detected for each job on the basis of the characteristic of the job type of specified in the above step (II), and categorizes the jobs specified for each type in the following manner.

(a) Preceding-Job Dependent Type

A file waiting job of the above (II-1) is not started unless a file generating job that another server 2 executes earlier has been executed. For this reason, it is appropriate to detect abnormality in the file waiting job by confirming the status of the preceding file generating job.

(b) Network Abnormality

The “file transfer” job, the “DB extraction” job, and the “DB updating” job of the above (II-2), (II-4), and (II-7) have execution statuses thereof depending on the network 1a connecting the local server 2 and another server 2 such as the transfer destination server 2 of the file or a DB server 2. For this reason, it is appropriate to detect abnormality in these jobs by confirming the status of the network 1a.

(c) Operation for Predetermined Time

The “wait for time point” job and the “infrastructure” job of the above (II-3) and (II-9) have respective constant execution time periods. For this reason, it is optimum to detect abnormality in these jobs by determining excess of a scheduled time period.

(d) Disk Abnormality

The “backup” job of the above (II-8) has an execution status depending on the disk of the destination of writing data. For this reason, it is appropriate to detect abnormality in the “backup” job by confirming the status of the disk.

(e) Data

It is optimum to detect abnormality in the “data processing” job and the “data aggregating” job of the above (II-5) and (II-6) by confirming the status of data processing.

The user may store, on the terminal 3, the above job categories (a) to (e) categorized in the above manner in the memory unit 21 in association with the job types to be the job category information 213.

In other words, the memory unit 21 that stores the job category information 213 is an example of a memory that stores a monitoring target (e.g., other preceding jobs or the DB server 2) that is to be monitored when determination related to abnormality of a job is to be made in association with the job.

The abnormality determiner 224 determines whether a job being executed by the execution controller 222 has abnormality on the basis of the categories of the jobs set in the job category information 213. For example, the abnormality determiner 224 may determine whether respective jobs executed by the execution controller 222 in the local server 2 have abnormality in the order of executing the jobs.

As described above, since the type (contents) of abnormality to be monitored is different with the category of a job, the abnormality determiner 224 specifies the category of the job being executed by referring to the job category information 213. In other words, since a monitoring target is different with the category of a job, it can be said that the abnormality determiner 224 is an example of a specifier that specifies a monitoring target associated with the target job by referring to the memory unit 21.

Then the abnormality determiner 224 obtains the monitoring information through monitoring possible abnormality of a target object associated with the specified category of the job, and determines whether the job has abnormality on the basis of the obtained monitoring information. For example, the abnormality determiner 224 can detect abnormality of a job early because being capable of confirming the status of an appropriate resource conforming to the category of the job.

Upon detecting abnormality of a job, the abnormality determiner 224 may notify the detected abnormality of the job. This notification may be accomplished by various methods such as outputting the information log of the abnormal job to the memory unit 21 or transmitting information related to the abnormal job to the terminal 3.

### (1-4) Description of the Abnormality Determiner

Hereinafter, description will now be made in relation to an abnormality determination process performed by the abnormality determiner 224 and being based on suitable for the category of a job by comparing with a comparative example.

### (1-4-1) Preceding-Job Dependent Type

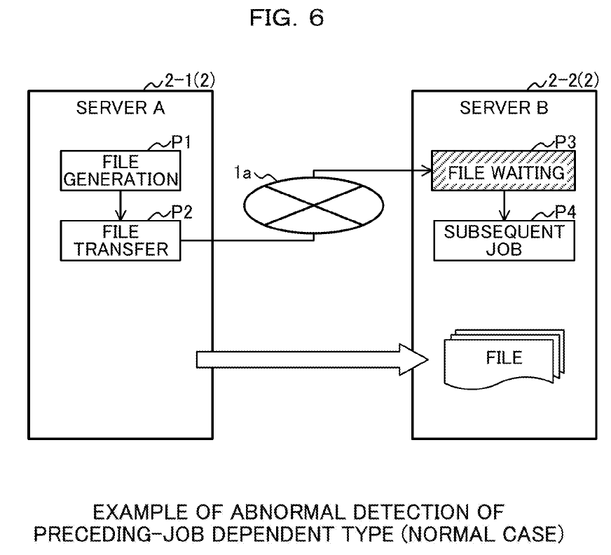

First of all, description will now be made in relation to a determination process for abnormality of a job of preceding-job dependent type of the above (a) by referring to FIGS. 6-10.

As exemplarily illustrated in FIG. 6, among the jobs P1-P4 to be executed by the servers 2-1 and 2-2, the file waiting job P3 executed by the server 2-2 will now be focused. In the following description, the servers 2-1 and 2-2 are represented by server A and B, respectively.

The file waiting job P3 is a job that waits, at the server B, for a file transferred from the server A through the network 1a. The file waiting job P3 is a job depending on the preceding file generating job P1 and the preceding file transfer job P2 which are executed in the server A.

The abnormality determiner 224 of the server B determines whether or not the jobs P1 and P2 of the server A preceding to the determination-target job P3 normally end within a scheduled execution time period set for the job P3. An example of the scheduled execution time period is a time period between the start time point of the file waiting job set in the job definition information 211 and the scheduled end time point obtained from the execution history information 212.

In the example of FIG. 6, the jobs P1 and P2 normally end within the scheduled execution time period set for the job P3 and therefore the job P3 normally ends.

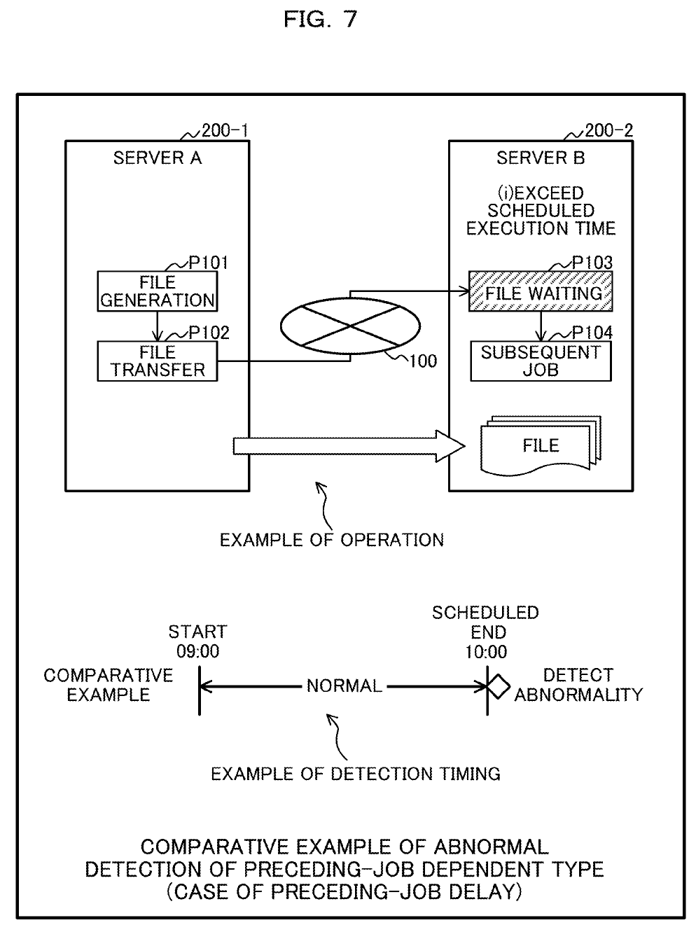

The comparative example illustrated in FIG. 7 assumes that at least one of the file generating job P101 and the file transfer job P102 delays and does not normally end within the scheduled execution time period set for the file waiting job P103. In this case, the statuses of the jobs P101 and P102, which are executed in another server A earlier, are not considered and therefore the file waiting job P103 is detected to have abnormality immediately when the scheduled execution time period is exceeded (expires) (see step (i) in FIG. 7).

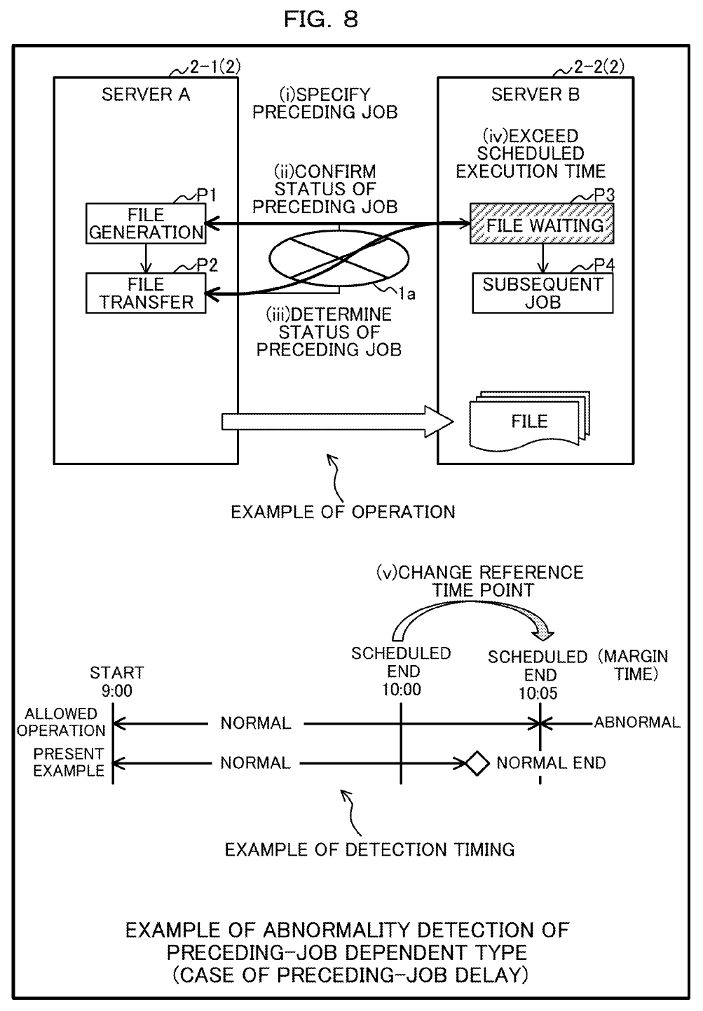

In contrast, as illustrated in FIG. 8, the abnormality determiner 224 of the present embodiment appropriately determines whether the job P3 has abnormality in the following procedure.

(i) The abnormality determiner 224 specifies the file generating job P1 and the file transfer job P2 both preceding to the file waiting job P3.

(ii) The abnormality determiner 224 confirms that the file generating job P1 normally ends, and then periodically confirms the status of the file transfer job P2.

For example, the abnormality determiner 224 may inquire requests the execution controller 222 of the other server A of the status (monitoring information) of the jobs P1 and P2 of the monitoring target. Examples of the status of a job include normal end, abnormal end, being executed, or a progress rate of the execution of the job. An example of the confirmation timing of the periodic inquiry may be a monitoring interval time of the job P3 set in the job definition information 211. Upon receipt of an inquiry, the execution controller 222 of the other server A obtains the statuses of the jobs P1 and P2 by referring to the execution history information 212 of the other server A and replies to the abnormality determiner 224 with the obtained statuses.

(iii) The abnormality determiner 224 calculates a scheduled receiving completion time point on the basis of the transfer capability (e.g., transfer rate, transfer size) at that time point to confirm the status of the file transfer job P2.

Here, the transfer rate can be obtained by the following Expression (1) and the scheduled receiving completion time point can be obtained by the following Expression (2) (the same applied to the description below). The transfer size is a size (entire size) of a file to be transferred, and can be obtained by, for example, inquiry to the execution controller 222.

transfer rate=current size/(current time point−actual start time point) (1)

scheduled receiving completion time point=current time point+(transfer size−current size)/transfer rate (2)

(iv) In cases where the time point of the above step (iii) is on or later than scheduled end time point (e.g., 10:00), the abnormality determiner 224 determines whether the time point of the step (iii) is on or earlier than an allowed scheduled end time point (e.g., 10:05) which corresponds to the time point incorporating (adding) a margin time (e.g., five minutes).

(v) In cases where the time point of the above step (iii) is on or earlier than the allowed scheduled end time point (e.g., 10:05), the abnormality determiner 224 delays a reference time point to detect whether or not the job P3 has abnormality because the file is expected to arrive, so that the job P3 can be escaped from being determined to abnormal at the scheduled end time point (i.e., 10:00).

For example, in the above step (v), the abnormality determiner 224 may delay the reference time point by overwriting the allowed scheduled end time point on the scheduled end time point or by adding the margin time to the scheduled end time point (the same applied to the description below).

Accordingly, as depicted by the allowed operation in FIG. 8, the timing of abnormality detection can be adjusted such that the job is determined to be normal until the allowed scheduled end time point (e.g., 10:05) passes, not scheduled end time point (e.g., 10:00) passes. For example, as depicted by the present example in FIG. 8, in cases where the job P3 ends at the time point between the scheduled end time point (e.g., 10:00) and the allowed scheduled end time point (e.g., 10:05), the abnormality determiner 224 detects that the job P3 normally ends.

In the present embodiment, the scheduled receiving completion time point of the above Expression (2) is calculated in connection with the scheduled receiving completion time point (reference time point), but the present embodiment is not limited to this. Alternatively, the abnormality determiner 224 may obtain the following Expression (3) in connection with the scheduled execution time period (reference time period) and may make the same determination in consideration of the margin time as the above (the same applied to the description below).

Scheduled receiving completion time period=(transfer size−current size)/transfer rate (3)

Since the scheduled receiving completion time period represents the time period from the current time point to a time point when the receiving is completed, the time passed from the actual start time point to the current time point may be added to the scheduled receiving completion time period when the scheduled receiving completion time period is compared with the scheduled execution time period (reference time period).

The job definition information 211 is defined and stored in units of each server 2. For this reason, it is difficult for the comparative example, which makes determination on a job for each server 200, to consider a job to be executed in another server 200.

In contrast to the above, the abnormality determiner 224 of the server B of the present embodiment can obtain the information about the jobs P1 and P2 executed in the server A through the following process in the above step (i).

(Specifying the File Transfer Job P2)

As illustrated in FIG. 3, for example, the job definition information 211 in the server A defines following data in regard of the file transfer job P2.

transfer source file name: “C:¥out1”

transfer destination server name: “server B”

transfer destination file name: “D:¥send1”

Likewise, the job definition information 211 in the server B defines following data in regard of the file waiting job P3.

waiting file name: “D:¥send1”

The abnormality determiner 224 of the server B specifies a job (file transfer job P2) having the following condition by accessing the server A from the server B through the network 1a and searching for the job definition information 211 of the server A.

transfer destination server name=server B

transfer destination server name=waiting file name of file waiting job P1=“D:¥send1”

(Specifying the File Generating Job P1)

As illustrated in FIG. 3, the job definition information 211 of the server A defines the following data in regard of the file generating job P1.

outputting file name: “C:¥out1”

The abnormality determiner 224 of the server B specifies a job (file generating job P1) having the following condition by accessing the server A from the server B through the network 1a and searching the job definition information 211 of the server A.

outputting filename=transfer source file name of file transfer job P2=“C:Yout1”

In the above manner, the abnormality determiner 224 searches the preceding jobs to the target job executed in the local server 2 one for each time in the reverse order of execution from the target job by referring to the job definition information 211 of the other server 2.

Consequently, the abnormality determiner 224 precisely determines whether the file waiting job P3 has abnormality on the basis of the execution statuses of the jobs in the other server A.

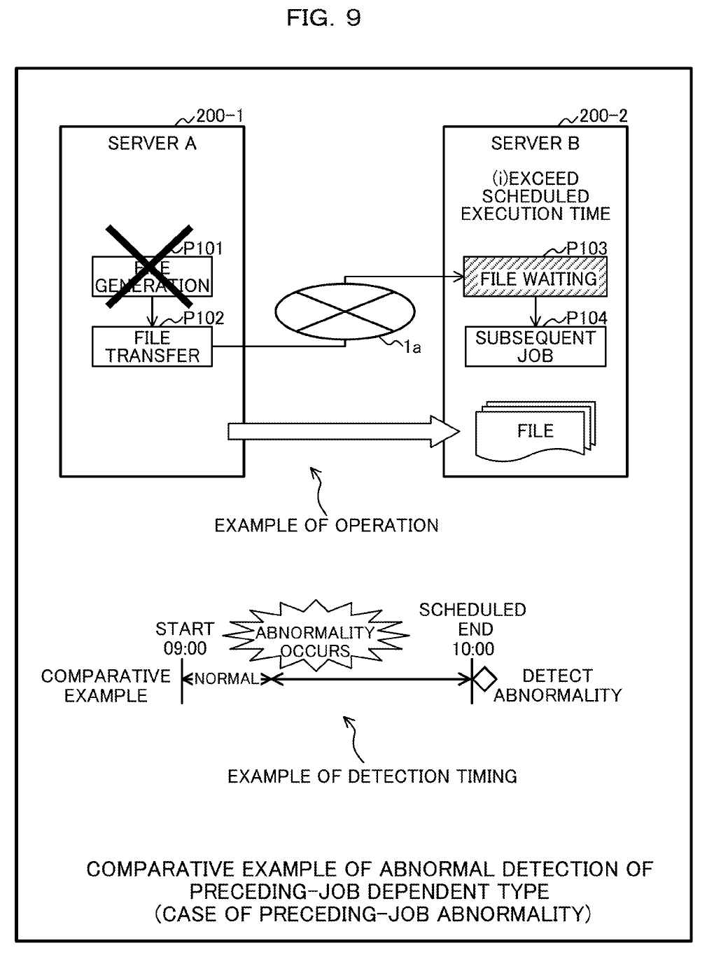

Another example will now be described. A comparative example of FIG. 9 assumes a case where abnormality occurs in, for example, a file generating job P101, and the file generating job P101 and the file transfer job P2 are not executed. In this case, since the statuses of the jobs P101 and P102 executed earlier in the other server A are not considered, the file waiting job P103 is not detected to have abnormality until the scheduled execution time period is exceeded.

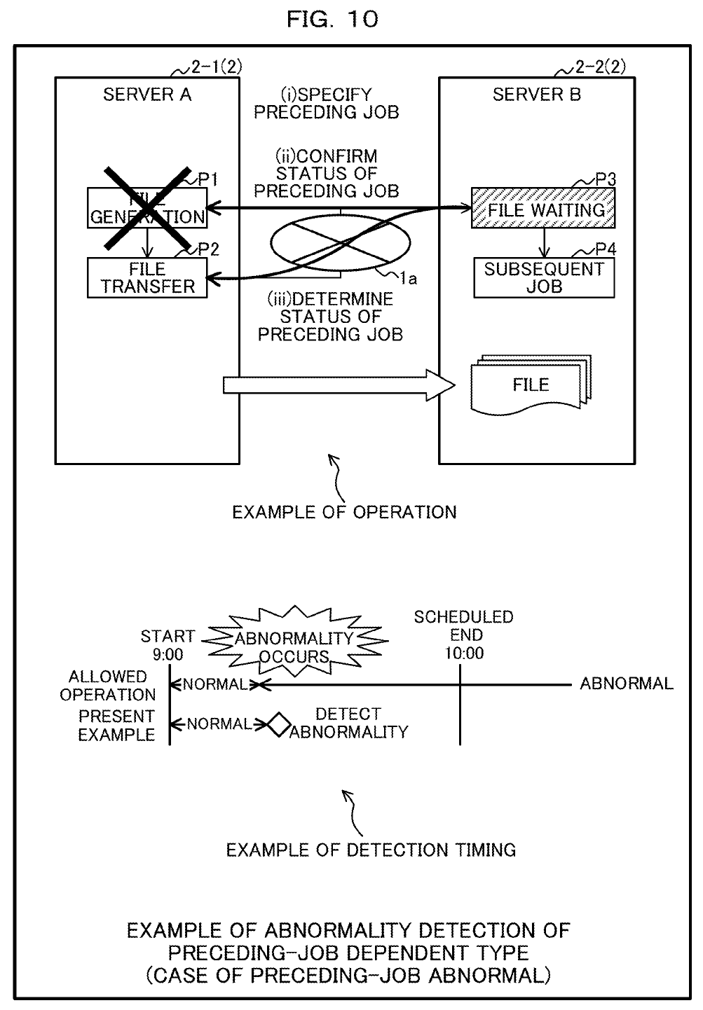

In contrast to the above, as illustrated in FIG. 10, the abnormality determiner 224 according to an embodiment can appropriately determine whether the job P3 has abnormality in the following procedure. The steps (i) and (ii) below are the same as those in the example of FIG. 8.

(i) The abnormality determiner 224 specifies the file generating job P1 and the file transfer job P2 both preceding to the file waiting job P3.

(ii) The abnormality determiner 224 periodically confirms the statuses of the file generating job P1 and the file transfer job P2.

(iii) In cases where the job P1 or P2 confirmed in above step (ii) is abnormal, the abnormality determiner 224 determines that the job P3 is abnormal, not waiting until the scheduled execution time period expires because the file is not expected to arrive.

As denoted to be the allowed operation and the present example in FIG. 10, the abnormality determiner 224 can detect the abnormality in the job P3 at a time point before the scheduled end time point (e.g., 10:00) passes and also until, at latest, the monitoring interval time passes since the abnormality has occurred.

### (1-4-2) Network Abnormality Type

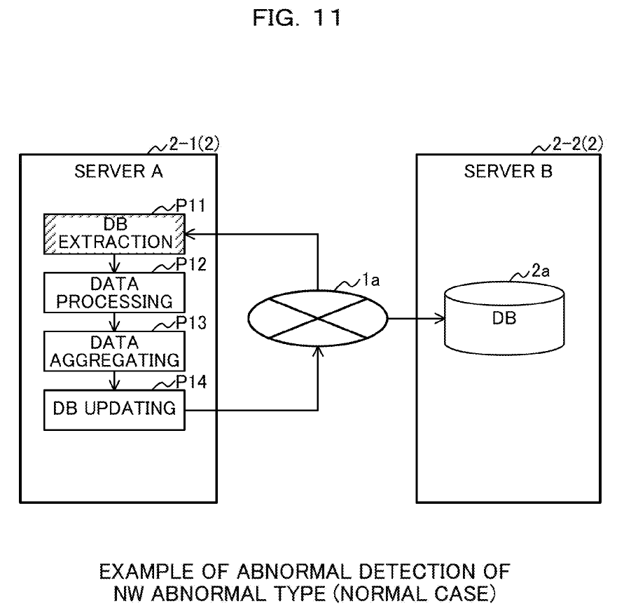

Next, description will now be made in relation to a determination process of abnormality in a job of a network abnormality type of the above category (b) with reference to FIGS. 11-15.

As exemplarily illustrated in FIG. 11, a DB extraction job P11 is focused among the jobs P11 to P14 executed by the server A. The DB extraction job P11 is a job that extracts data from DB 2a of the DB server B through the network 1a.

In the example of FIG. 11, no abnormality occurs in the network 1a and the job P11 normally ends within the scheduled execution time period set for the job P11.

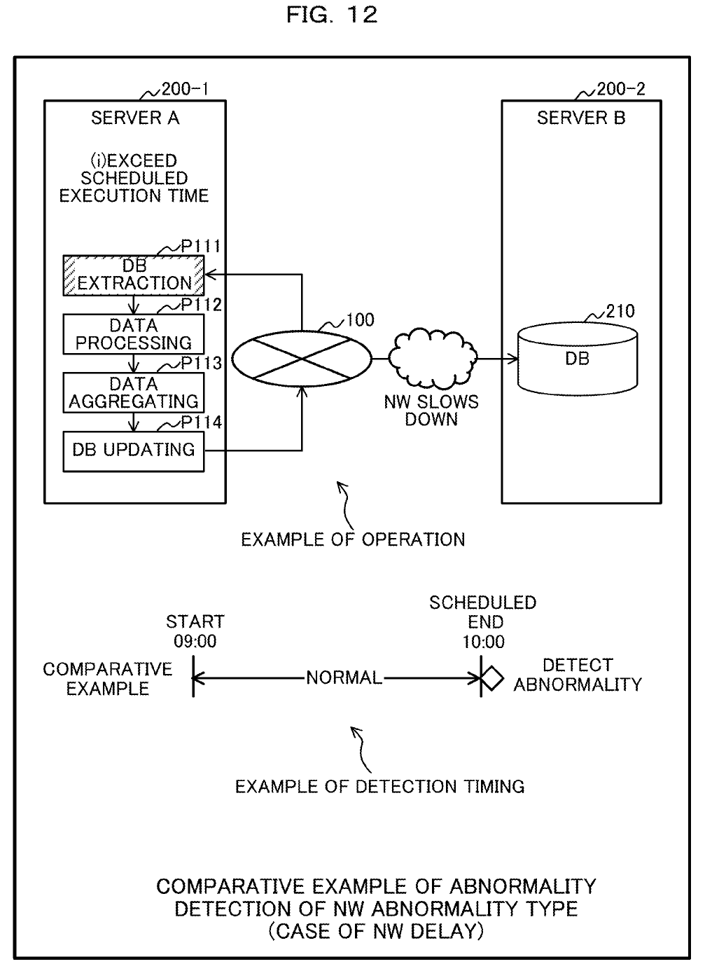

On the other hand, the comparative example of FIG. 12 assumes a case where the network 100 slows down and consequently the DB extraction job P111 delays and does not normally end within the scheduled execution time period. In this case, since the status (capability) of the network 100 is not considered, the DB extraction job P111 is detected to have abnormality at the time point immediately exceeding the scheduled execution time period (see step (i) of FIG. 12).

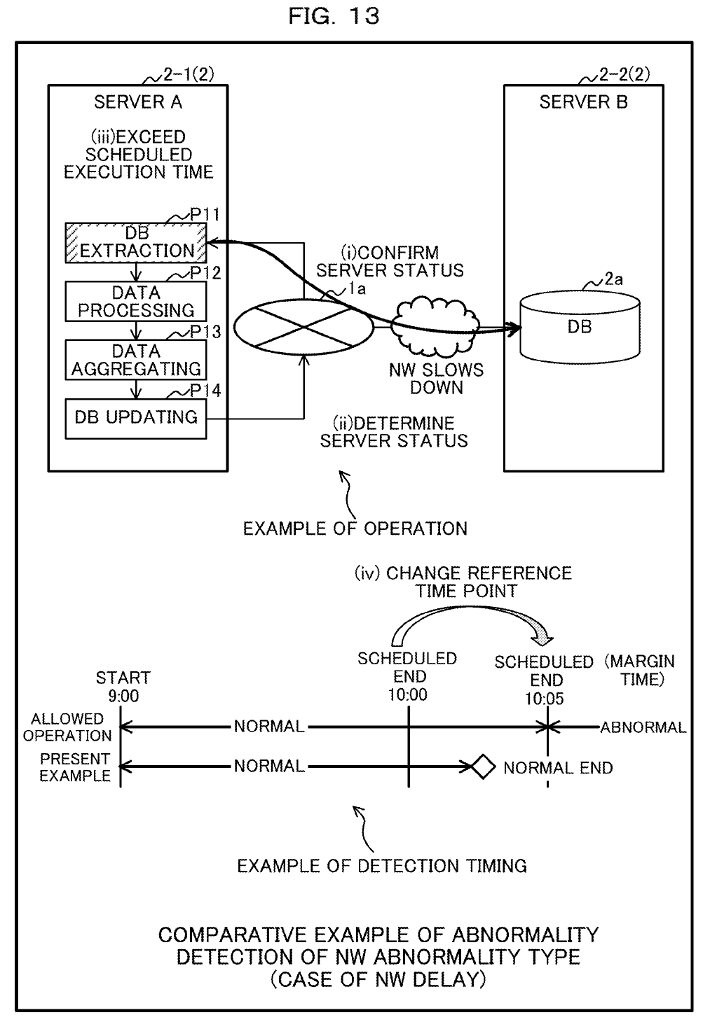

In contrast, as illustrated in FIG. 13, the abnormality determiner 224 of the server A of the present embodiment appropriately determines whether the job P11 has abnormality in the following procedure.

(i) The abnormality determiner 224 periodically confirms the status of the DB server B.

For example, the abnormality determiner 224 may periodically carry out ping or the like on the BC server B and confirms that the DB server 2 replies with a response.

(ii) The abnormality determiner 224 calculates a scheduled extracting completion time point on the basis of the transfer capability (e.g., transfer rate, transfer size) at that time point to confirm the status of the DB server B.

The transfer rate can be calculated by using the above Expression (1) to calculate a transfer rate described with reference to FIG. 8. The scheduled extracting completion time point can be calculated by replacing the scheduled receiving completion time point in above Expression (2) described by referring to FIG. 8 with a scheduled extracting completion time point.

(iii) In cases where the time point of the above step (ii) is on or later than the scheduled end time point (e.g., 10:00), the abnormality determiner 224 determines whether the time point of the step (ii) is on or earlier than an allowed scheduled end time point (e.g., 10:05) which corresponds to the time point incorporating (adding) a margin time (e.g., five minutes).

(iv) In cases where the time point of the above step (ii) is on or earlier than the allowed scheduled end time point (e.g., 10:05), the abnormality determiner 224 delays a reference time point to detect whether or not the job P11 has abnormality because the extraction is expected to be completed, so that the job P11 can be escaped from being determined to be abnormal at the scheduled end time point (i.e., 10:00) because the file is expected to complete extracting.

Accordingly, as depicted by the allowed operation in FIG. 13, the timing of abnormality detection can be adjusted such that the job is determined to be normal until the allowed scheduled end time point (e.g., 10:05) passes, not scheduled end time point (e.g., 10:00) passes. For example, as depicted by the present example in FIG. 13, in cases where the job P11 ends at the time point between the scheduled end time point (e.g., 10:00) and the allowed scheduled end time point (e.g., 10:05), the abnormality determiner 224 detects that the job P3 normally ends.

Consequently, the abnormality determiner 224 precisely determines whether the DB extraction job P11 has abnormality on the basis of the network statuses between the server A and the other server B.

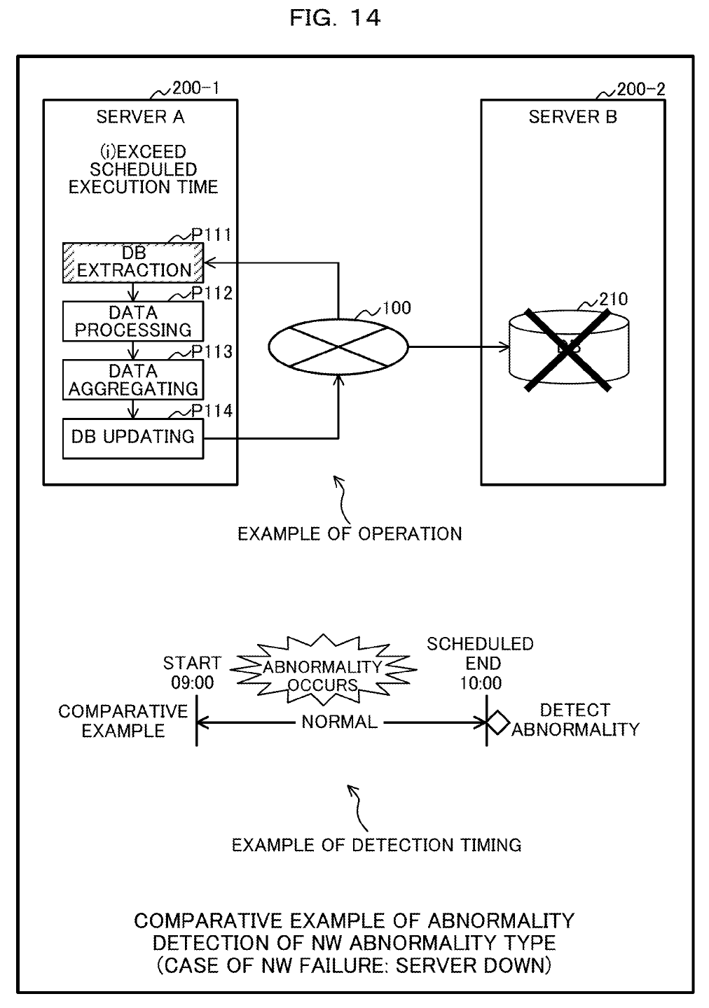

Another example will now be described. A comparative example of FIG. 14 assumes a case where abnormality occurs in, for example, the DB 210 of the other server B, and the DB extraction job P111 is not executed. In this case, since the statues (capability) of the network 100 is not considered, the DB extraction job P111 is not detected to have abnormality until the scheduled execution time period expires.

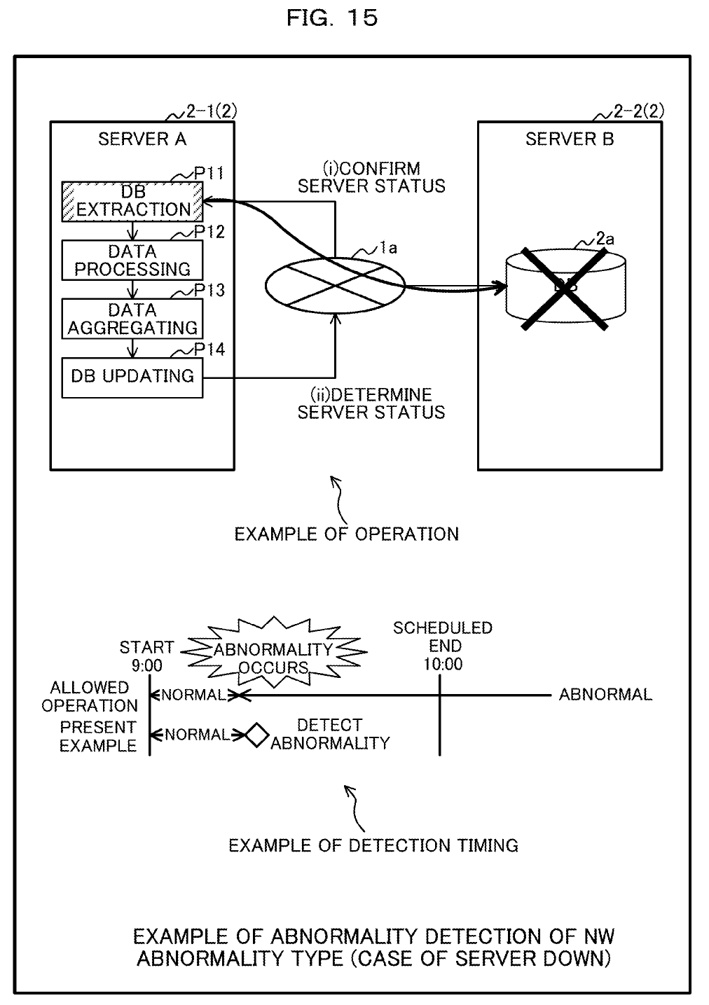

In contrast, as illustrated in FIG. 15, the abnormality determiner 224 of the present embodiment appropriately determines whether the job P11 has abnormality in the following procedure.

(i) The abnormality determiner 224 periodically confirms the status of the DB server B.

(ii) In cases where the abnormality determiner 224 recognizes that the DB server B has abnormality because, for example, the DB server B does not respond to ping directed to the DB server B in the above step (i), the abnormality determiner 224 determines that the job P11 is abnormal, not waiting until the scheduled execution time period expires.

As denoted to be the allowed operation and the present example in FIG. 15, the abnormality determiner 224 can detect the abnormality in the job P11 at a time point before the scheduled end time point (e.g., 10:00) passes and also until, at latest, the monitoring interval time passes since the abnormality has occurred.

### (1-4-3) Predetermined-Time Operation Type

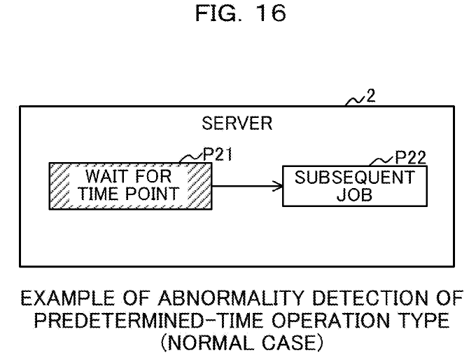

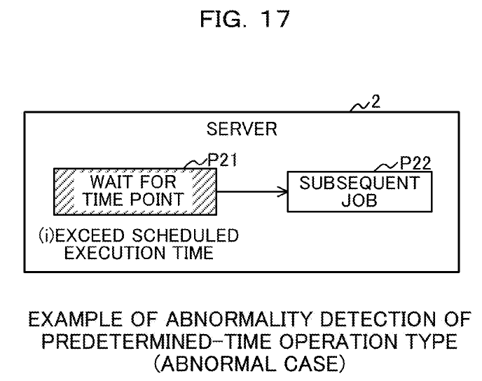

Next, description will now be made in relation to a determination process for abnormality in a job of a predetermined-time operation type of the above (c) by referring to FIGS. 16 and 17.

As exemplarily illustrated in FIG. 16, among the jobs P21 and P22 to be executed by the server 2, the “wait for time point” job P21 is focused. A “wait for time point” job P21 is a job that waits until the time point set therein comes.

In the example of FIG. 16, the job P21 normally ends by the time point set in the job P21.

On the other hand, FIG. 17 assumes, for example, a case that processing delay occurs in the server 2 and consequently the “wait for time point” job P21 delays and does not normally end within the scheduled execution time period. In this case, the “wait for time point” job P21 is detected to be abnormal immediately at the time point exceeding the scheduled execution time period (see step (i) in FIG. 17).

As illustrated in the job category information 213 of FIG. 5, since it is appropriate to determine whether a job of the predetermined-time operation type has abnormality on the basis of a time period, the abnormality determiner 224 may determine whether the job P21 has abnormality on the basis of a scheduled execution time period like a traditional method.

Otherwise, in cases where a margin time is set for a job of the predetermined-time operation type, the abnormality determiner 224 may detect that the job P21 has abnormality if the job P21 does not end by the allowed scheduled end time point obtained by adding the margin time to the scheduled end time point set for the job P21.

### (1-4-4) Disk Abnormality Type

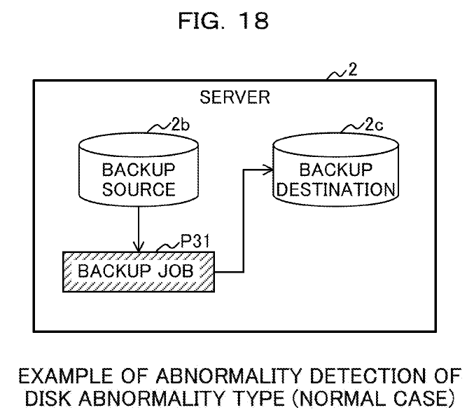

Description will now be made in relation to a determination process for abnormality in a job of the disk abnormality type of the above (d) by referring to FIGS. 18-22.

As exemplarily illustrated in FIG. 18, a backup job P31 executed by the server 2 will now be focused. The backup job P31 is a job that backs up data in a backup source 2b in the server 2 to a backup destination 2c in the same server 2.

In the example of FIG. 18, no abnormality occurs in both backup source 2b and the backup destination 2c, and consequently the job P31 normally ends within the scheduled execution time period set in the job P31.

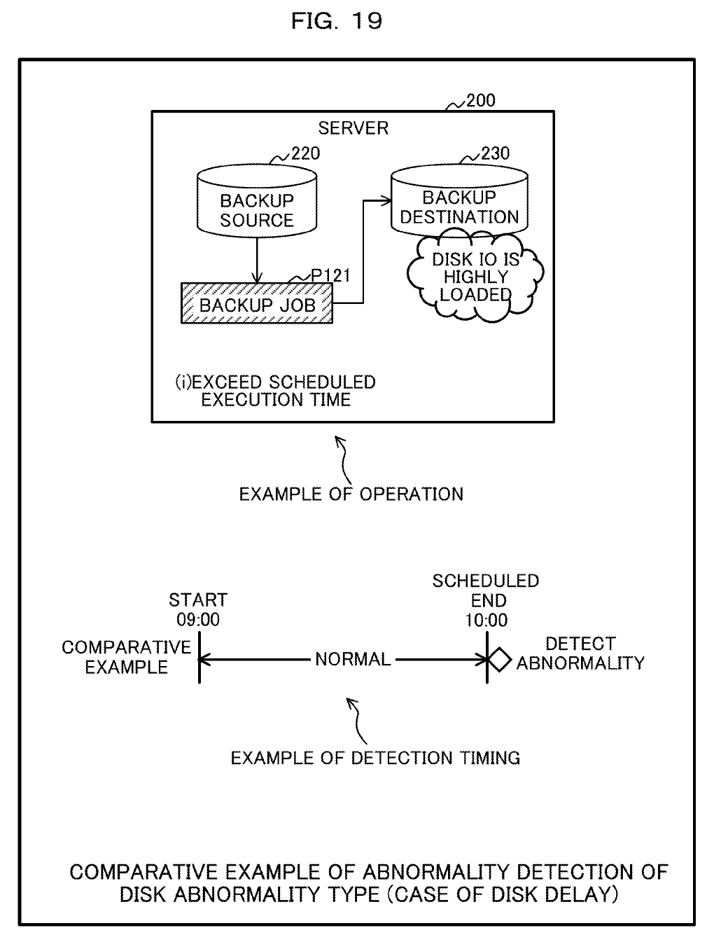

On the other hand, the comparative example of FIG. 19 assumes a case where the disk IO is highly loaded in the backup destination 230 and consequently the backup job P121 delays and does not normally end within the scheduled execution time period. In this case, since the status (capability) of the disk is not considered, the backup job P121 is detected to have abnormality at the time point immediately exceeding the scheduled execution time period (see step (i) of FIG. 19).

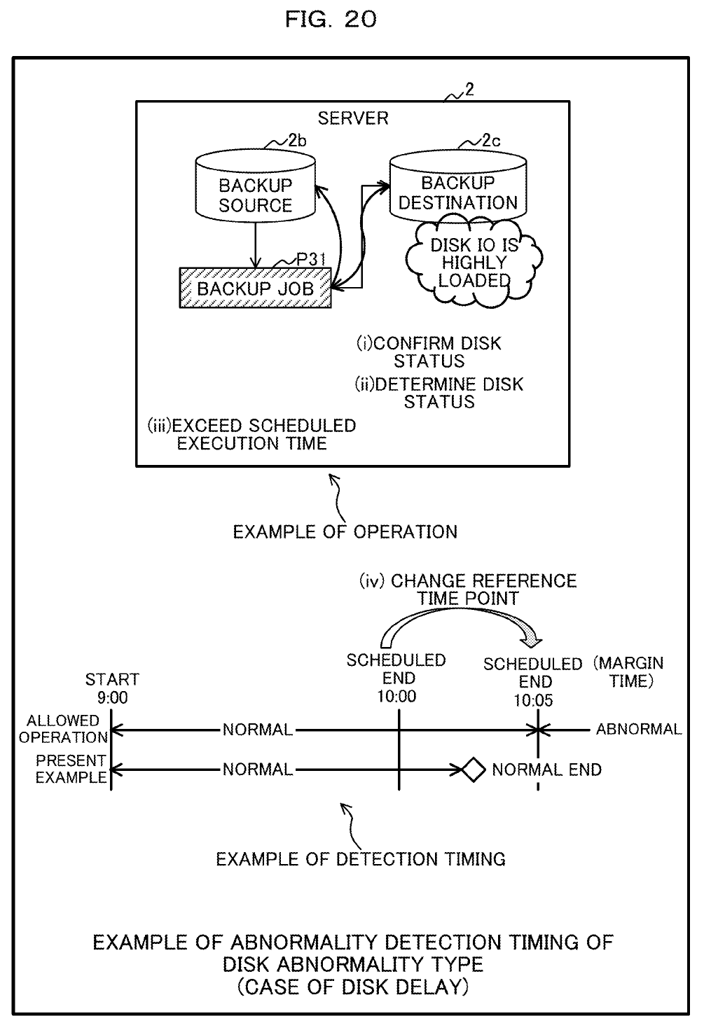

In contrast, as illustrated in FIG. 20, the abnormality determiner 224 of the server 2 of the present embodiment appropriately determines whether the job P31 has abnormality in the following procedure.

(i) The abnormality determiner 224 periodically confirms a status of at least one disk of the backup source 2b and the backup destination 2c.

For example, the abnormality determiner 224 periodically transmits a command, such as an iostat command, for confirming the status of the disk to the disk and confirms that the disk replies with a response.

(ii) The abnormality determiner 224 calculates a scheduled backup completion time point on the basis of the disk capability (e.g., reading rate and/or writing rate, reading size and/or writing size) at that time for confirming the status of the disk.

The reading rate and/or writing rate can be calculated by replacing the transfer rate of the above Expression (1) to described by referring to FIG. 8 with the reading rate and/or writing rate. The scheduled backup completion time point can be calculated by replacing the term of the scheduled receiving completion time point and the transfer size in above Expression (2) described by referring to FIG. 8 with a scheduled backup completion time point and reading size and/or writing size, respectively.

(iii) In cases where the time point of the above step (ii) is on or later than scheduled end time point (e.g., 10:00), the abnormality determiner 224 determines whether the time point of the step (ii) is on or earlier than an allowed scheduled end time point (e.g., 10:05) which corresponds to the time point incorporating (adding) a margin time (e.g., five minutes).

(iv) In cases where the time point of the above step (ii) is on or earlier than the allowed scheduled end time point (e.g., 10:05), the abnormality determiner 224 delays a reference time point to detect whether or not the job P31 has abnormality because the backup is expected to be completed, so that the job P31 can be escaped from being determined to be abnormal at the scheduled end time point (i.e., 10:00).

Accordingly, as depicted by the allowed operation in FIG. 20, the timing of abnormality detection can be adjusted such that the job is determined to be normal until the allowed scheduled end time point (e.g., 10:05) passes, not scheduled end time point (e.g., 10:00) passes. For example, as depicted by the present example in FIG. 20, in cases where the job P31 ends at the time point between the scheduled end time point (e.g., 10:00) and the allowed scheduled end time point (e.g., 10:05), the abnormality determiner 224 determines that the job P31 normally ends.

Consequently, the abnormality determiner 224 precisely determines whether the backup job P31 has abnormality on the basis of the disk statuses in the server 2.

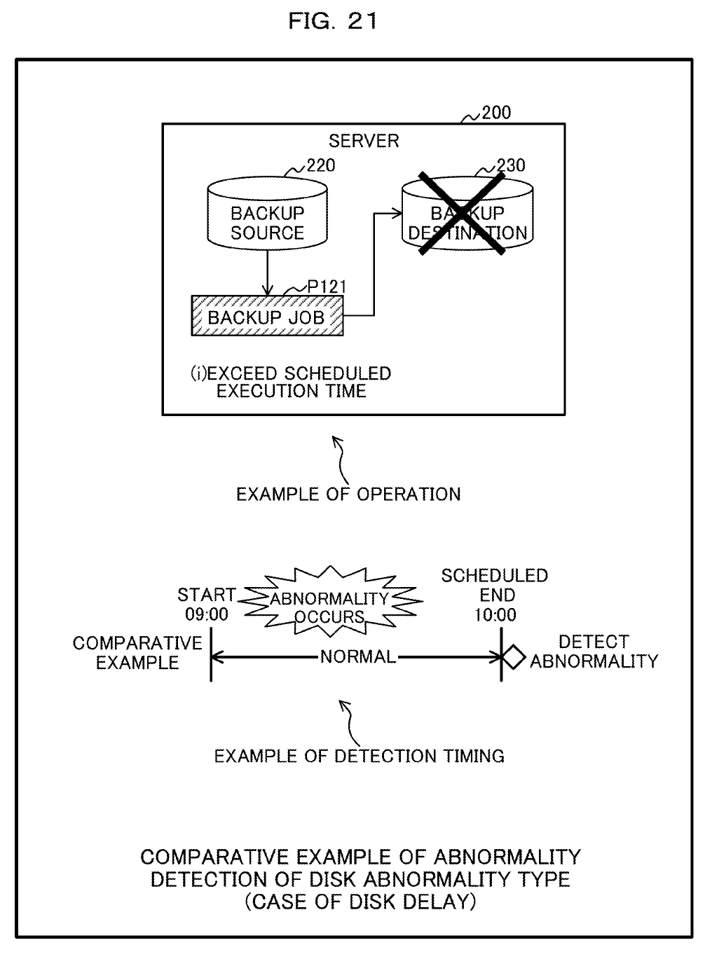

Another example will now be described. A comparative example of FIG. 21 assumes a case where abnormality occurs in, for example, a disk of the backup destination 230 and the backup job P121 is not executed. In this case, since the statues (capability) of the disk is not considered, the backup job P121 is not detected to have abnormality until the scheduled execution time period expires.

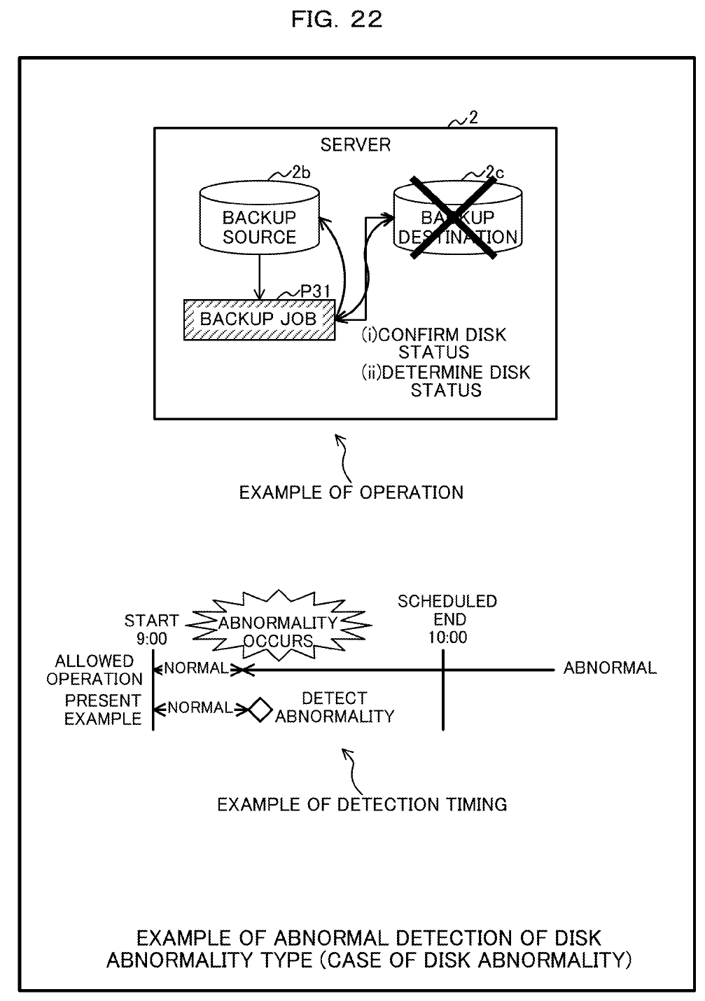

In contrast, as illustrated in FIG. 22, the abnormality determiner 224 of the present embodiment appropriately determines whether the job P31 has abnormality in the following procedure.

(i) The abnormality determiner 224 periodically confirms the status of a disk of at least one of the backup source 2b and the backup destination 2c.

(ii) In cases where the abnormality determiner 224 recognizes that the disk has abnormality because, for example, the disk does not respond to a command for confirming the status of the disk in the above step (i), the abnormality determiner 224 determines that the job is abnormal, not waiting until the scheduled execution time period expires.

As denoted by the allowed operation and the present example in FIG. 22, the abnormality determiner 224 can detect the abnormality in the job P31 at a time point before the scheduled end time point (e.g., 10:00) passes and also until, at latest, the monitoring interval time passes since the abnormality has occurred.

### (1-4-5) Data

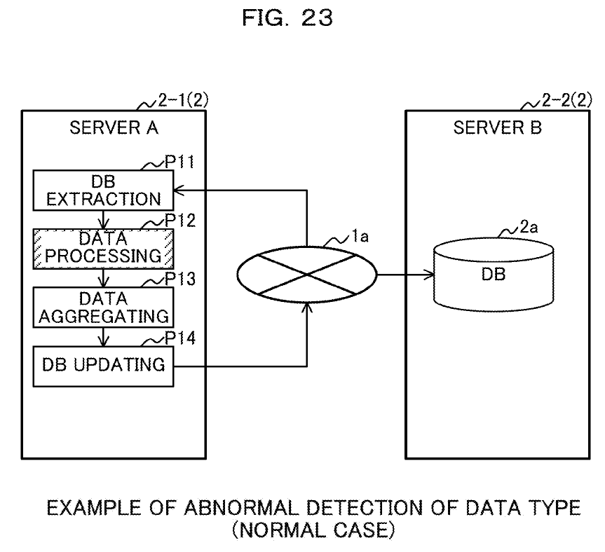

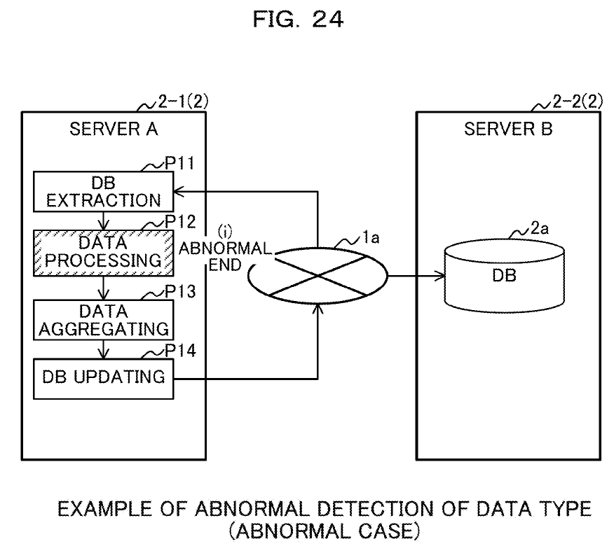

Next, description will now be made in relation to a determination process for abnormality in a job of a data type of the above category (e) with reference to FIGS. 23 and 24.

As exemplarily illustrated in FIG. 23, a data processing job P12 is focused among the jobs P11 to P14 to be executed by the server A. The data processing job P12 is a job that processes data that the DB extraction job P11 extracts from DB 2a of the server B.

In the example of FIG. 23, the job P12 normally ends.

On the other hand, in cases where the data processing job P12 abnormally ends as illustrated in FIG. 24, the data processing job P12 is detected to have abnormality at the time point of the abnormal end (see step (i) of FIG. 24).

Since it is appropriate to detect whether a job of the data type has abnormality on the basis of whether or not the job ends normally (or whether or not the data is normal), the abnormality determiner 224 may detect whether the job P12 has abnormality like a traditional method.

As described above, determination as to whether or not jobs of the preceding-job dependent, the network abnormality, and the disk abnormality of the above categories (a), (b), and (d) have abnormality can be correctly made by considering the respective characteristics of the jobs.

For example, the abnormality determiner 224 determines whether jobs of the above categories (a), (b), and (d) have abnormality by using the allowed scheduled end time point obtained by adding a margin time to the scheduled end time point. This can apprehended that the scheduled end time point (period) is updated to a new scheduled end time point (period).

This means that the abnormality determiner 224 is an example of an updater that updates a first reference time point or a first reference time period to a second (i.e., new) reference time point or a second (i.e., new) reference time period on the basis of monitoring information obtained through monitoring the specified monitoring target. The updating is performed (i.e., the margin time is added to the (first) reference time point or the (first) reference time period) when the target job is determined on the basis of the monitoring information to end during a time period from the first reference time point to the second time point or a time period beyond the first reference time period but within the second reference time period, for example.

The abnormality determiner 224 is an example of a determiner that determines whether the target job has abnormality on the basis of the second reference time point and the second reference time period.

As described above, in cases where a failure of a monitoring target is detected on the basis of the monitoring information, the abnormality determiner 224 may determine that the target job has abnormality at the time point of detecting the failure not waiting until the reference time point comes or not waiting for expiration of the reference time period.

The control that determines the job to have abnormality not waiting until the reference time point comes or not waiting for expiration of the reference time period as the above may be executed on the jobs of the preceding-job dependent type, the network abnormality, and the disk abnormality of the above categories of (a), (b), and (d) in the following case. For example, in cases where the scheduled completion time point of receiving, extraction, or backup is detected to exceed the allowed scheduled end time point containing the margin time, the abnormality determiner 224 may detect the abnormality of a job at the timing when this detection is made.

In other words, in cases where the target job is determined not to end by the second reference time point or within the second reference time period on the basis of the monitoring information, the abnormality determiner 224 may determine that the target job has abnormality, not waiting until the second reference time point comes or not waiting for expiration of the second reference time period.

Transition from on-premise environment to cloud environment of a system may cause a problem in the local system due to an influence from another system sharing the same resource with the local system. The state of resource that a job uses is blackboxed and is therefore information difficult to be easily obtained.

According to a method of the present embodiment, the following advantage makes it possible to appropriately deal with a problem after confirming the states of resources that the job is using, so that the batch operation can be stably conducted.

For example, the categorizer 223 can categorize jobs to be executed, and the abnormality determiner 224 can monitor a monitoring target (e.g., other jobs, a network, a DB server, and a disk) for the category of the job and determine whether the job is normal or abnormal on the basis of the result of monitoring. This eliminates a requirement of manpower for determination as to whether the job is normal or abnormal.

In cases where a job is completed within the allowed scheduled end time point obtained by adding the margin time to the scheduled end time point, the job, which is expected to normally end if a grace time period is provided, can be executed without being aborted. This save the consumption of resource in the server 2 for a recovery process such as execution of a job again.

Furthermore, in cases where a job does not end or is not completed by an allowed scheduled end time point, the abnormality determiner 224 can abort the job before the scheduled end time point. As described above, the abnormality of the job can be detected at its early stage, so that the job can undergo a recovery process rapidly.

### (1-5) Example of Operation

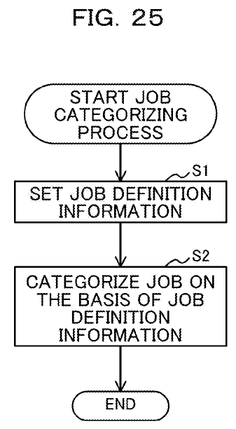

Next, description will now be made in relation to an example of operation of the server 2 having the above configuration with reference to FIGS. 25-32.

(1-5-1) Example of Operation in a Job Categorizing Process

First of all, an example of a job categorizing process will now be detailed. As illustrated in FIG. 25, the scheduler 221 sets job definition information 211 based on, for example, information received from the terminal 3 and stores the job definition information 211 in the memory unit 21 (Step S1).

The categorizer 223 obtains the type of each job by referring to the job definition information 211, categorizes the job on the basis of the job category information 213 (Step S2), and then ends the process.

### (1-5-2) Example of Operation of a Job Execution Control

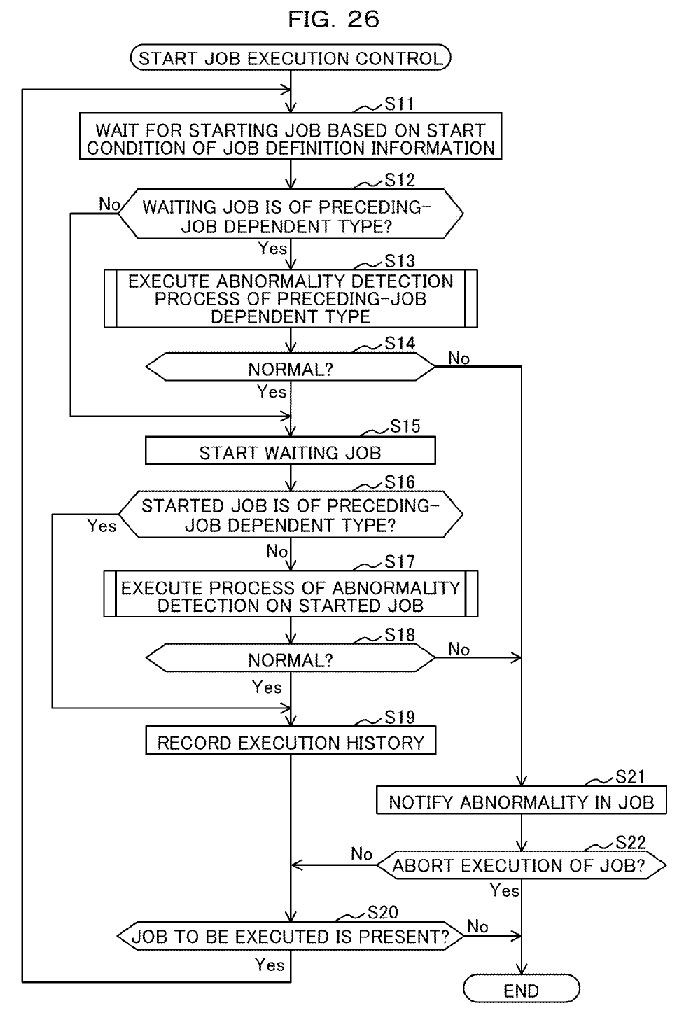

Next, an example of operation of a job execution control will now be detailed. As illustrated in FIG. 26, the scheduler 221 waits for starting a job on the basis of the start condition (e.g., the time point comes) by referring to the job definition information 211 (Step S11). The information of the job that has waited for being started (hereinafter also referred to as a “waiting job”) may be notified to the abnormality determiner 224 from the scheduler 221.

The abnormality determiner 224 determines whether or not the waiting job pertains to the preceding-job dependent type of the above category (a) (Step S12). If the job does not pertain to the preceding-job dependent type (No in Step S12), the process moves to Step S15.

If the waiting job pertains to the preceding-job dependent type (Yes in Step S12), the abnormality determiner 224 executes a process of abnormality detection compatible with the preceding-job dependent type (Step S13) and determines whether or not the result of the abnormality detection is normal (Step S14). Example of a process of abnormality detection on a job of the preceding-job dependent type is a process of abnormality detection related to not satisfying the start condition such as the start condition is not satisfied even when the start time point comes.

If the result of the process of abnormality detection is normal (Yes in Step S14), which means that satisfying of the start condition is detected, the scheduler 221 instructs the execution controller 222 to start the job. The execution controller 222 starts the business program 23 of the job on the basis of the job definition information 211 (Step S15).

Next, the abnormality determiner 224 detects whether or not the started job pertains to the preceding-job dependent type (Step S16). If the started job pertains to the preceding-job dependent type (Yes in Step S16), the process moves to Step S19.

If the started job does not pertain to the preceding-job dependent type (No in Step S16), the started job pertains to one type of the above categories (b) to (e). In this case, the abnormality determiner 224 executes the process of abnormality detection on the started job (Step S17) and determines whether or not the result of the process of abnormality detection is normal (Step S18).

If the result of the process of abnormality detection is normal (Yes in Step S18), the execution controller 222 records the execution history in the execution history information 212 of the memory unit 21 (Step S19).

The scheduler 221 determines whether or not a job to be executed (“waiting job”) is present by referring to the job definition information 211 (Step S20). If the job is absent (No in Step S20), the process ends. In contrast, if the job to be executed is present (Yes in Step S20), the process moves to step S11.

If the result of the process of abnormality detection in Step S14 or S19 is abnormal (No in Step S14 or No in Step S19), the abnormality determiner 224 notifies abnormality in the job (Step S21).

After notifying the abnormality in the job, the abnormality determiner 224 determines whether or not to abort execution of the subsequent jobs (Step S22). If the jobs are not aborted (No in Step S22), the process moves to Step S20. In contrast, if the subsequent jobs are aborted (Yes in Step S22), the process ends.

Whether or not the execution of jobs is aborted may be determined on the based on, for example, the solution list (not illustrated) defined in advance to deal with failures. The execution of jobs is aborted when abnormality that makes it difficult to continue the jobs in, for example, a batch process occurs.

(1-5-3) Process of Abnormality Detection of a Job of Preceding-Job Dependent Type

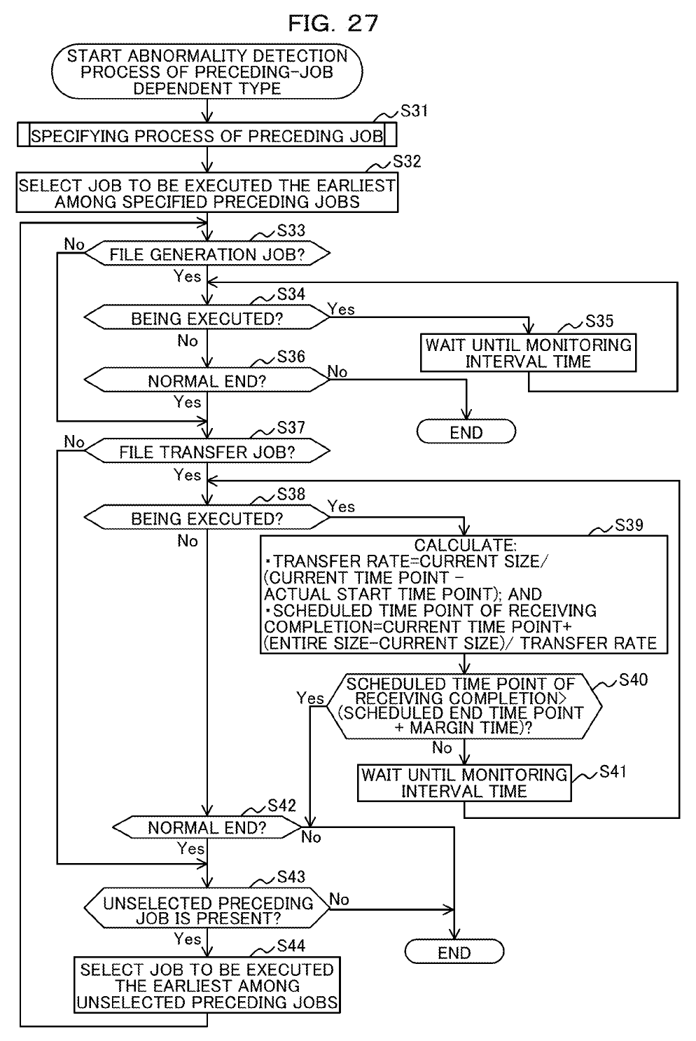

Next, description will now be made in relation to an example of an operation in a process of abnormality detection on a job of the preceding-job dependent type in Step S13 of FIG. 26. As illustrated in FIG. 27, the abnormality determiner 224 executes a specifying process of a preceding job to the job of the preceding-job dependent type (Step S31).

The abnormality determiner 224 selects the job to be executed the earliest among the specified preceding jobs (Step S32).

The abnormality determiner 224 determines whether the selected job is a file generating job (Step S33). If the selected job is a file generating job (Yes in Step S33), the abnormality determiner 224 determines whether the file generating job is being executed (Step S34).

If the file generating job is being executed (Yes in Step S34), the abnormality determiner 224 waits for passage of the monitoring interval time of a job of the preceding-job dependent type set in the job definition information 211 (Step S35), and then the process moves to Step S34.

In contrast, if the file generating job is not being executed (No in Step S34), the abnormality determiner 224 determines whether or not the file generation job has normally ended (Step S36). If the file generating job has not normally ended (No in Step S36), the process ends.

If the selected job is determined not to be a file generating job in Step S33 (No in Step S33) or if the file generating job normally end in Step S36 (Yes in Step S36), the process moves to Step S37.

In Step S37, the abnormality determiner 224 determines whether or not the selected job is a file transfer job. If the job is a file transfer job (Yes in Step S37), the abnormality determiner 224 determines whether the file transfer job is being executed (Step S38).

If the file transfer job is being executed (Yes in Step S38), the abnormality determiner 224 calculates the scheduled receiving completion time point based on the above Expressions (1) and (2) (Step S39). This calculation may use various pieces of information such as the transfer size (entire size) of a file, size (current size) that has currently been transferred, the current time point, and the actual start time point of the file transfer job.

Next, the abnormality determiner 224 determines whether the scheduled receiving completion time point is later than the time point (allowed scheduled end time point) obtained by adding the margin time to the scheduled end time point (Step S40). If the scheduled receiving completion time point is on or earlier than the allowed scheduled end time point (No in Step S40), the abnormality determiner 224 waits for passage of the monitoring interval time of a job of the preceding-job dependent type set in the job definition information 211 (Step S41) and then the process moves to Step S38.

On the other hand, if the scheduled receiving completion time point is later than the allowed scheduled end time point (Yes in Step S40), the process is determined to have abnormality and ends.

In Step S38, if the file transfer job is not being executed as a result of the determination in Step S38 (No in Step S38), the abnormality determiner 224 determines whether or not the file transfer job has normally ended (Step S42). If the file transfer job has not normally ended (No in Step S42), the process ends.

If the selected job is determined not to be a file transfer job in Step S37 (No in Step S37) or if the file transfer job is determined to have normally ended in Step S42 (Yes in Step S42), the process moves to Step S43.

In Step S43, the abnormality determiner 224 determines whether or not a preceding job not having been selected in Step S32 is present. If an unselected preceding job is absent (No in Step S43), the process ends.

In contrast, if an unselected preceding job is present (Yes in Step S43), the abnormality determiner 224 selects the preceding job that is executed the earliest among the unselected preceding jobs (Step S44) and then the process moves to Step S33.

(1-5-4) Specifying Process of a Preceding Job

Next, description will now be made in relation to an example of operation of a specifying a preceding job in Step S31 of FIG. 27. The following example assumes that the abnormality determiner 224 of the server B specifies a preceding job executed in the server A.

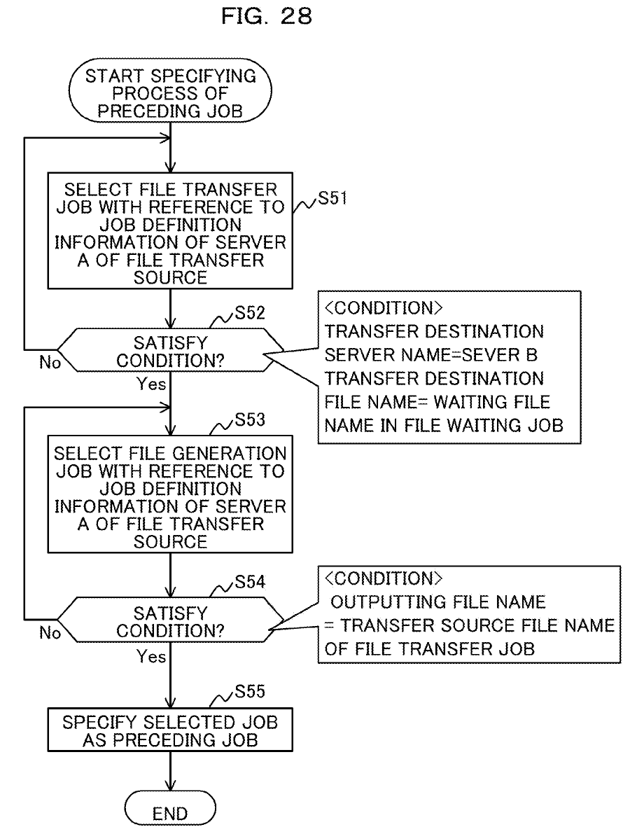

As illustrated in FIG. 28, the abnormality determiner 224 selects a job having a job type of a file transfer with reference to the job definition information 211 of the server A, which is the file transfer source (Step S51).

The abnormality determiner 224 determines whether or not the selected file transfer job satisfies the condition by referring to the job definition information 211 (Step S52). If the selected file transfer job does not satisfy the condition (No in Step S52), the process moves to Step S51. An example of the condition here is that the transfer destination server name of the file transfer job is the server B and also the transfer destination file name of the file transfer job is the file name of a waiting file of the file waiting job.

If the selected file transfer job satisfies the condition (Yes in Step S52), the abnormality determiner 224 selects a job having a job type of a file generating by referring to the job definition information 211 of the server A, which is the file transfer source (Step S53).

The abnormality determiner 224 determines whether or not the selected file generating job satisfies the condition by referring to the job definition information 211 (Step S54). If the selected file generating job does not satisfy the condition (No in Step S54), the process moves to Step S53. The condition here is that the transfer destination server name of the file transfer job is the server B and also the transfer destination file name of the file transfer job is the file name of the waiting file of the file waiting job.

If the selected file generating job satisfies the condition (Yes in step S54), the abnormality determiner 224 specifies the selected job to be a preceding job to the file waiting job (Step S55) and ends the process.

The example of FIGS. 27 and 28 assumes that the preceding jobs are a file generating job and a file transfer job, but the present embodiment is not limited to this. The type of a preceding job may be different with the relationship of the jobs set in the job definition information 211. Examples of a preceding job is a job that can be set as a batch operation and also can be executed in a local server 2 or another server 2.

(1-5-5) Process of Abnormality Detection on Started Job

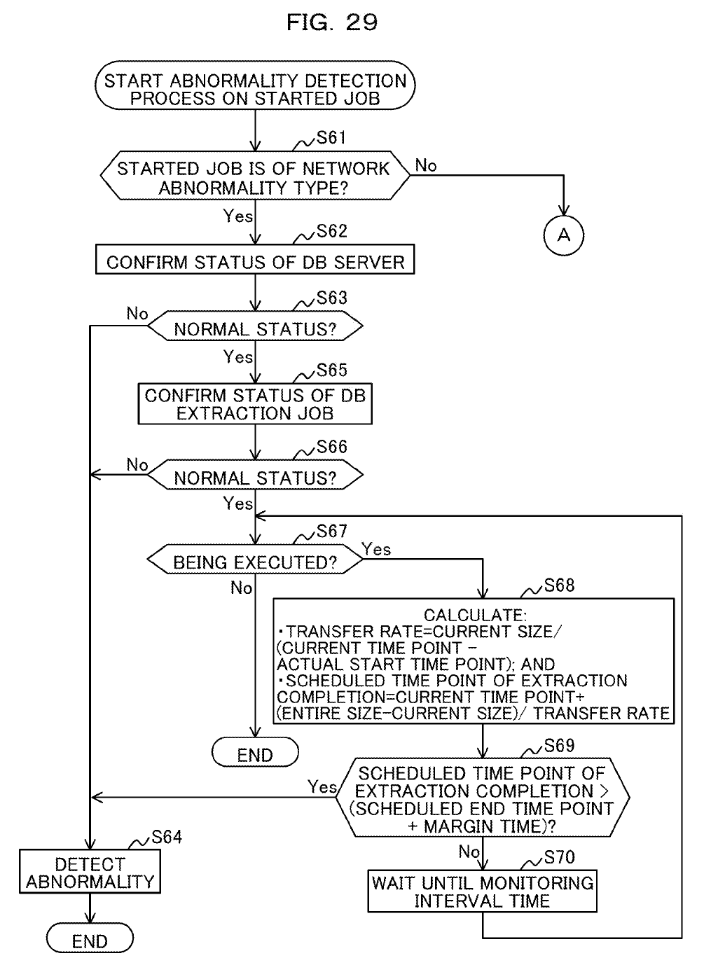

Next description will now be made in relation to an example of operation of a process of abnormality detection on the job started in Step S17 of FIG. 26. As illustrated in FIG. 29, the abnormality determiner 224 determines whether or not the started job is of the network abnormality type of the above category (b) (Step S61).

If the started job is of the network abnormality type (Yes in Step S61), the abnormality determiner 224 confirms the status of the communication destination (e.g., DB server 2) of the job (Step S62) and determines whether or not the DB server is in a normal status (Step S63).

If the DB server 2 is not in a normal status (No in step S63) which is exemplified by not responding, the abnormality determiner 224 detects abnormality (Step S64) and ends the process.

In contrast, if the DB server 2 is in the normal status (Yes in Step S63), the abnormality determiner 224 confirms the status of a job of the network abnormality type such as a DB extraction job (Step S65) and confirms whether or not the DB extraction job is in a normal status (Step S66).

If the DB extraction job is not in a normal status (No in Step S66), the process moves to Step S64. In contrast, if the DB extraction job is in a normal status (Yes in Step S66), the abnormality determiner 224 determines whether or not the DB extraction job is being executed (Step S67).

If the DB extraction job is not being executed (No in Step S67), the process ends. In contrast, if the DB extraction job is being executed (Yes in Step S67), the abnormality determiner 224 calculates the transfer rate and the scheduled extracting completion time point based on the above Expressions (1) and (2) (Step S68). This calculation may use various pieces of information such as the transfer size (entire size) of data, size (current size) that has currently been transferred, the current time point, and the actual start time point of the DB extraction job.

Next, the abnormality determiner 224 determines whether or not the scheduled extracting completion time point is later than the time point (allowed scheduled end time point) obtained by adding the margin time to the scheduled end time point (Step S69). If the scheduled extracting completion time point is on or earlier than the allowed scheduled end time point (No in Step S69), the abnormality determiner 224 waits for passage of the monitoring interval time of a job of the network abnormality type set in the job definition information 211 (Step S70) and then moves the process to Step S67.

On the other hand, if the scheduled extracting completion time point is later than the allowed scheduled end time point (Yes in Step S69), the process moves to step S64.

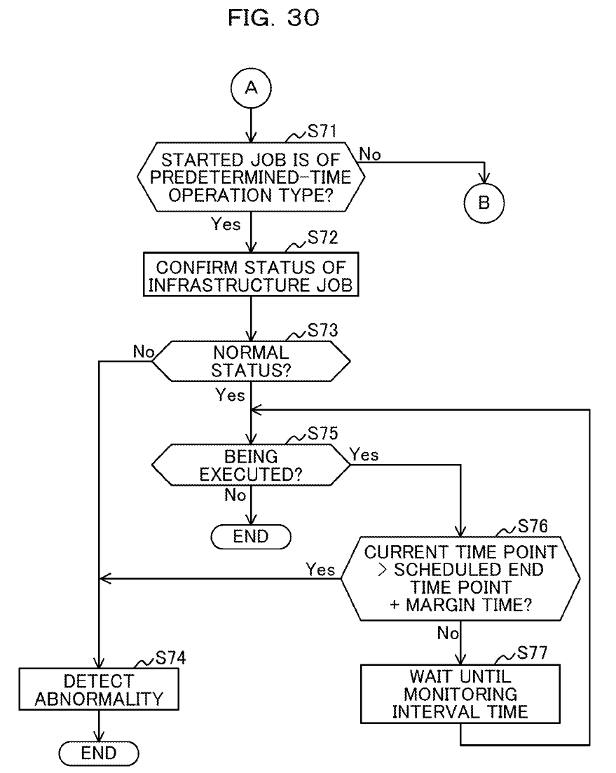

If the activated job is determined not to be of the network abnormality type (No in Step S61), the process moves to Step S71 of FIG. 30.

As illustrated in FIG. 30, the abnormality determiner 224 determines whether or not the started job is of the predetermined-time operation type of the above category (c) (Step S71).

If the started job is of the predetermined-time operation type (Yes in Step S71), the abnormality determiner 224 confirms the status of the job of the predetermined-time operation type exemplified by an infrastructure job (Step S72) and confirms whether or not the infrastructure job is in the normal status (Step S73).

If the infrastructure job is not in a normal status (No in Step S73), the abnormality determiner 224 detects the abnormality (Step S74) and ends the process. In contrast, if the infrastructure job is in the normal status (Yes in Step S73), the abnormality determiner 224 confirms whether or not the infrastructure job is being executed (Step S75).

If the infrastructure job is not being executed (No in Step S75), the process ends. In contrast, if the infrastructure job is being executed (Yes in Step S75), the abnormality determiner 224 determines whether the current time point is later than the time point (allowed scheduled end time point) obtained by adding the margin time to the scheduled end time point (Step S76). In cases where the current time point is on or earlier than the allowed scheduled end time point (No in Step S76), the abnormality determiner 224 waits for passage of the monitoring interval time of a job of the predetermined-time operation type set in the job definition information 211 (Step S77) and then the process moves to Step S75.

On the other hand, in cases where the current time point is later than the allowed scheduled end time point (Yes in Step S76), the process moves to step S74.

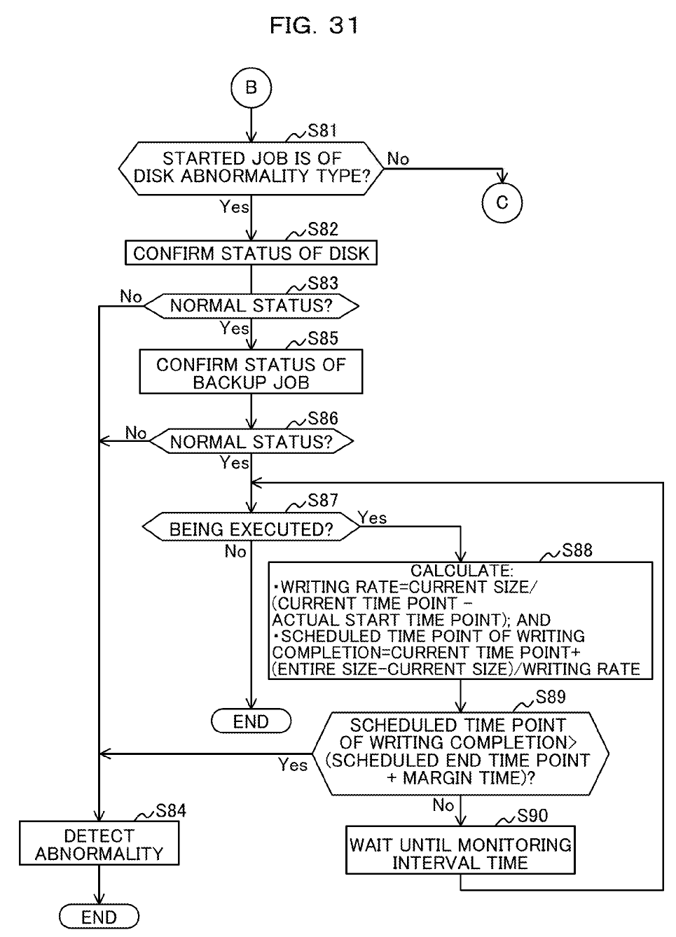

If the activated job is determined not to be of the predetermined-time operation type (No Step S71), the process moves to Step S81 of FIG. 31.

As illustrated in FIG. 31, the abnormality determiner 224 determines whether or not the started job is of the disk abnormality type of the above category (d) (Step S81).

In the started job is of the disk abnormality type (Yes in Step S81), the abnormality determiner 224 confirms the status of the access destination of the job exemplified by a disk (Step S82) and confirms whether or not the disk is in the normal status (Step S83).

If the disk is not in a normal status (No in Step S83) because, for example, not responding, the abnormality determiner 224 detects the abnormality (Step S84) and ends the process.

In contrast, if the disk is not in a normal status (Yes in Step S83), the abnormality determiner 224 confirms the status of the job of the disk abnormality type, such as a backup job (Step S85) to confirm whether or not the backup job is in a normal status (Step S86).

If the backup job is not in a normal status (No in Step S86), the process moves to Step S84. In contrast, if the backup job is in a normal status (Yes in Step S86), the abnormality determiner 224 determines whether or not the backup job is being executed (Step S87).

If the backup job is not being executed (No in Step S87), the process ends. In contrast, if the backup job is being executed (Yes in Step S87), the abnormality determiner 224 calculates, for example, a writing rate and/or a scheduled writing completion time point based on the above Expressions (1) and (2) (Step S88). This calculation may use various pieces of information such as the writing size (entire size) of data, size (current size) that has currently been written, the current time point, and the actual start time point of the backup job.

Next, the abnormality determiner 224 determines whether or not the scheduled writing completion time point is later than the time point (allowed scheduled end time point) obtained by adding the margin time to the scheduled end time point (Step S89). If the scheduled writing completion time point is on or earlier than the allowed scheduled end time point (No in Step S89), the abnormality determiner 224 waits for passage of the monitoring interval time of a job of the disk abnormality type set in the job definition information 211 (Step S90) and then the process moves to Step S87.

On the other hand, if the scheduled writing completion time point is later than the allowed scheduled end time point (Yes in Step S89), the process moves to step S84.

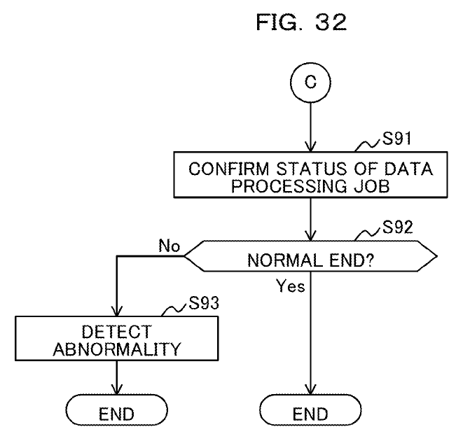

If the started job in Step S81 is not of the disk abnormality type (No in Step S81), the started job is a job of the data type. In this case, the process moves to Step S91 in FIG. 32.

As illustrated in FIG. 32, the abnormality determiner 224 confirms the status of a job of the data type such as a data processing job (Step S91) to determine whether or not the job has normally ended (Step S92).

If the data processing job has not normally ended (No in Step S92), the abnormality determiner 224 detects the abnormality (Step S93), and ends the process. In contrast, if the data processing job has normally ended (Yes in Step S92), the process ends.

### (1-6) Example of a Hardware Configuration

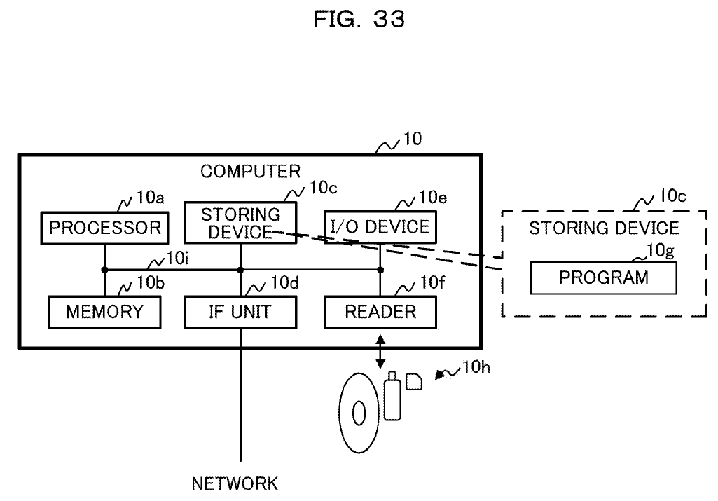

Next, description will now be made in relation to an example of the hardware configuration of the server 2 according to an embodiment by referring to FIG. 33. Hereinafter, description will now be made in relation to an example of the hardware configuration of a computer 10 regarded as an example of the server 2.

As illustrated in FIG. 33, the computer 10 may exemplarily include a processor 10a, a memory 10b, a storing device 10c, an Interface (IF) unit 10d, an Input/Output (I/O) device 10e, and a reader 10f.

The processor 10a is an example of an arithmetic processing device that executes various controls and calculations. The processor 10a may be bidirectionally and communicably connected to the hardware blocks in the computer 10 via a bus 10i. An example of the processor 10a may be an Integrated Circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA).

The memory 10b is an example of a hardware device that stores various pieces of data and programs. An example of the memory 10b is a volatile memory such as a RAM.

The storing device 10c is an example of a hardware device that stores various pieces of data and programs. Examples of the storing device 10c are various type of storing device including a magnetic storing device such as a HDD, a semiconductor drive such as an SSD, and a non-volatile memory. Examples of the non-volatile memory are a Storage Class Memory (SCM) and a Read Only Memory (ROM).

The memory unit 21 of the server 2 illustrated in FIG. 2 may be achieved by at least one of the memory 10b and the storing device 10c of the server 2.

The storing device 10c may store a program 10g that achieves all or part of the functions of the computer 10. The processor 10a expands a program (e.g., determining program) 10g stored in the storing device 10c on the memory 10b and executes the expanded program and thereby achieves the function as the job manager 22 illustrated in FIG. 2.

The IF unit 10d is an example of a communication IF that, for example, controls connection and communication with the network 1a. For example, the IF unit 10d may include an adaptor conforming to a LAN or optical communication (e.g., Fiber Channel (FC)). For example, the program 10g may be downloaded from the network 1a to the computer 10 through the communication IF and then stored in the storing device 10c.

The I/O unit 10e may include at least either one of an input device such as a mouse, a keyboard, and an operation button; and an output device such as a monitor exemplified by a touch panel display or a Liquid Crystal Display (LCD), a projector, and a printer.

The reader 10f is an example of a reader that reads data and a program recorded in a recording medium 10h. The reader 10f may include a connector terminal or device that is connectable to or receivable a recording medium 10h. Examples of the reader 10f are an adaptor conforming to a Universal Serial Bus (USB), a drove that makes an access to a recording disk, and a card reader that makes an access to a flash memory such as an SD card. The recording medium 10h may store the program 10g and the reader 10f may read the program 10g from the recording medium 10h and then store the program into the recording device 10c.

An example of a recording medium 10h is a non-transitory recording medium such as a magnetic/optical disk and a flash memory. Examples of the magnetic/optical disk are a flexible disk, a Compact Disc (CD), a Digital Versatile Disc (DVD), a Blu-ray disk, and a Holographic Versatile Disc (HVD). Examples of a flash memory are a USB memory and an SD card. Examples of a CD are CD-ROM, CD-R, and CD-RW. Examples of a DVD are DVD-ROM, DVD-RAM, DVD-R, DVD-RW, DVD+R, and DVD+RW.

The above hardware of the computer 10 is merely an example. Accordingly, the hardware devices can appropriately be added or removed (e.g., addition or removal of an arbitrary block), separated, and integrated in any combination, and a bus can also be arbitrarily added or removed.

### (2) Miscellaneous

The embodiment described above can undergo the following changes and modifications.

For example, the respective functional blocks of the server 2 of FIG. 2 can be combined in any combination or separated.

The processor 10a of the computer 10 illustrated in FIG. 33 is not limited to a single processor or a single-core processor, and may alternatively be a multi-processor or a multi-core processor.

At least part of the function of the job manager 22 illustrated in FIG. 2 may be arranged so as to be distributed to or redundant in an apparatus (not illustrated) except for the server 2 through the network 1a and/or 1b.

One of the aspects of the embodiment, a determination related to abnormality of a job can be appropriately made in accordance with the circumstance.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a determining program for causing a computer to execute a process comprising:
specifying a monitoring target associated with a target job by referring to a memory configured to store a monitoring target in association with the target job, the monitoring target being monitored in a determination process, the determination process determining, based on whether the target job finishes by a first reference time point or within a first reference time period, whether the target job has abnormality;
updating the first reference time point or the first reference time period to a second reference time point or a second reference time period, respectively, based on monitoring information obtained through monitoring the specified monitoring target; and
determining, based on the second reference time point or the second reference time period, whether the target job has abnormality.

2. The non-transitory computer-readable recording medium according to claim 1, wherein the process further comprising:
updating the first reference time point or the first reference time period to the second reference time point or the second reference time period, respectively, when determining that the target job finishes between the first reference time point and the second reference time point or within the second time period beyond the first time period.

3. The non-transitory computer-readable recording medium according to claim 2, wherein the process further comprising:
updating the first reference time point or the first reference time period to the second reference time point or the second reference time period, respectively, by adding a margin time for which a delay of finishing the target job is allowed to the first reference time point or the first reference time period with reference to a storing device configured to store the margin time in association with the target job.

4. The non-transitory computer-readable recording medium according to claim 1, wherein the process further comprising:
when detecting a failure of the monitoring target by referring to the monitoring information, determining that the target job is abnormal, not waiting until the first reference time point comes or not waiting for expiration of the first reference time period.

5. The non-transitory computer-readable recording medium according to claim 1, wherein the process further comprising:
when determining that the target job does not finish by the second reference time point or within the second reference time period, determining that the target job is abnormal, not waiting until the first reference time point comes or not waiting for expiration of the first reference time period.

6. The non-transitory computer-readable recording medium according to claim 1, wherein the process further comprising:
calculating a scheduled end time point or a scheduled end time period of the target job based on a transfer rate of data to the monitoring target by the target job and either one of a former start time point and a former execution time period of the target job; and
determining whether to update the first reference time point or the first reference time period by comparing the first reference time point with the scheduled end time point or comparing the first reference time period with the scheduled end time period.

7. A computer-implemented method for determining, the method comprising:
specifying a monitoring target associated with a target job by referring to a memory configured to store a monitoring target in association with the target job, the monitoring target being monitored in a determination process, the determination process determining, based on whether the target job finishes by a first reference time point or within a first reference time period, whether the target job has abnormality;
updating the first reference time point or the first reference time period to a second reference time point or a second reference time period, respectively, based on monitoring information obtained through monitoring the specified monitoring target; and
determining, based on the second reference time point or the second reference time period, whether the target job has abnormality.

8. The computer-implemented method according to claim 7, further comprising:
updating the first reference time point or the first reference time period to the second reference time point or the second reference time period, respectively, when determining that the target job finishes between the first reference time point and the second reference time point or within the second time period beyond the first time period.

9. The computer-implemented method according to claim 8, further comprising:
updating the first reference time point or the first reference time period to the second reference time point or the second reference time period, respectively, by adding a margin time for which a delay of finishing the target job is allowed to the first reference time point or the first reference time period with reference to a storing device configured to store the margin time in association with the target job.

10. The computer-implemented method according to claim 7, further comprising:
when detecting a failure of the monitoring target by referring to the monitoring information, determining that the target job is abnormal, not waiting until the first reference time point comes or not waiting for expiration of the first reference time period.

11. The computer-implemented method according to claim 7, further comprising:
when determining that the target job does not finish by the second reference time point or within the second reference time period, determining that the target job is abnormal, not waiting until the first reference time point comes or not waiting for expiration of the first reference time period.

12. The computer-implemented method according to claim 7, further comprising:
calculating a scheduled end time point or a scheduled end time period of the target job based on a transfer rate of data to the monitoring target by the target job and either one of a former start time point and a former execution time period of the target job; and
determining whether to update the first reference time point or the first reference time period by comparing the first reference time point with the scheduled end time point or comparing the first reference time period with the scheduled end time period.

13. An apparatus for determining, the apparatus comprising:
a memory;
a processor that is connected to the memory and that is configured to determine, based on whether a target job finishes by a first reference time point or within a first reference time period, whether the target job has abnormality, wherein
the memory is configured to store a monitoring target in association with the target job, the monitoring target being monitored in a determination process; and
the processor is configured to:
specify the monitoring target associated with the target job by referring to the memory;
update the first reference time point or the first reference time period to a second reference time point or a second reference time period, respectively, based on monitoring information obtained through monitoring the specified monitoring target; and
determine, based on the second reference time point or the second reference time period, whether the target job has abnormality.

14. The apparatus according to claim 13, wherein the processor is further configured to update the first reference time point or the first reference time period to the second reference time point or the second reference time period, respectively, when determining that the target job finishes between the first reference time point and the second reference time point or within the second time period beyond the first time period.

15. The apparatus according to claim 14, wherein the processor is further configured to update the first reference time point or the first reference time period to the second reference time point or the second reference time period, respectively, by adding a margin time for which a delay of finishing the target job is allowed to the first reference time point or the first reference time period with reference to a storing device configured to store the margin time in association with the target job.

16. The apparatus according to claim 13, wherein the processor is further configured to determine, when detecting a failure of the monitoring target by referring to the monitoring information, that the target job is abnormal, not waiting until the first reference time point comes or not waiting for expiration of the first reference time period.

17. The apparatus according to claim 13, wherein the processor is further configured to determine, when determining that the target job does not finish by the second reference time point or within the second reference time period, that the target job is abnormal, not waiting until the first reference time point comes or not waiting for expiration of the first reference time period.

18. The apparatus according to claim 13, wherein the processor is further configured to:
calculate a scheduled end time point or a scheduled end time period of the target job based on a transfer rate of data to the monitoring target by the target job and either one of a former start time point and a former execution time period of the target job; and
determine whether to update the first reference time point or the first reference time period by comparing the first reference time point with the scheduled end time point or comparing the first reference time period with the scheduled end time period.
